(19) United States
(12) Patent Application Publication
(10) Pub. No.: US 2018/0052939 A1
(43) Pub. Date: Feb. 22, 2018

(54) SYSTEMS AND METHODS FOR CATEGORIZING WEBPAGE BOOKMARKS

(71) Applicant: QUALCOMM Incorporated, San Diego, CA (US)

(72) Inventors: Stewart Chao, Markham (CA); Shiu Wai Hui, Richmond Hill (CA); Veluppillai Arulesan, Toronto (CA)

(21) Appl. No.: 15/243,530

(22) Filed: Aug. 22, 2016

(51) Int. Cl. G06F 17/30

(52) U.S. Cl. CPC G06F 17/30884; G06F 17/30598

(57) ABSTRACT

A method for webpage bookmark categorization is described. The method includes determining to add a bookmark for a webpage. The method additionally includes accessing a linking navigation history. The method also includes determining at least one bookmark category of at least one linking webpage based on the linking navigation history or of a least one link on the webpage. The method further includes adding a bookmark for the webpage in the at least one bookmark category.

### FIELD OF DISCLOSURE

The present disclosure relates generally to electronic devices. More specifically, the present disclosure relates to systems and methods for categorizing webpage bookmarks.

### BACKGROUND

Some electronic devices (e.g., computers, laptop computers, cellular phones, smartphones, tablet devices, game consoles, televisions, automobiles, appliances, cameras, set-top boxes, etc.) communicate with other devices. For example, a smartphone may access a local area network (LAN) and/or a wide area network (WAN) (e.g., the Internet). Electronic devices may send data to and/or receive data from one or more devices.

As technology improves, more devices are being used to communicate with other devices. Additionally, many devices are communicating with other devices more often. For example, many people access the Internet for work and recreational purposes many times throughout the day.

As device intercommunication increases, the variety of data and number of sources accessed via intercommunication are expanding. It is becoming increasing difficult to manage the variety of data and numerous sources used. As can be observed from this discussion, systems and methods that improve ease of access may be beneficial.

### SUMMARY

A method for webpage bookmark categorization is described. The method includes determining to add a bookmark for a webpage. The method also includes accessing a linking navigation history. The method further includes determining at least one bookmark category of at least one linking webpage based on the linking navigation history or of at least one link on the webpage. The method additionally includes adding a bookmark for the webpage in the at least one bookmark category. The linking navigation history may indicate whether navigation to the webpage was accomplished with or without linking.

Determining the at least one bookmark category of the at least one linking webpage may include accessing at least a portion of a linking navigation history data structure. Adding the bookmark for the webpage may include categorizing the bookmark in each bookmark category indicated by the at least a portion of the linking navigation history data structure.

Determining the at least one bookmark category of the at least one link on the webpage may include determining whether each of the at least one link has a corresponding bookmark category. Adding the bookmark for the webpage may include categorizing the bookmark in each bookmark category corresponding to the at least one link.

The method may include creating a linking navigation history data structure based on one or more webpage accesses. Creating the linking navigation history data structure may include, for each of the one or more webpage accesses, creating a data structure entry corresponding to a webpage access based on whether the webpage access is via a linking webpage, via a linking webpage in a separate tab or window, or without a linking webpage.

The linking navigation history data structure may include a tree. Creating the data structure entry corresponding to the webpage access may include creating a first branch from a current node in a case that the webpage access is via a linking webpage, creating a second branch from the current node in a case that the webpage access is via a linking webpage in a separate tab or window, or creating a branch from a root node in a case that the webpage access is without a linking webpage.

The linking navigation history data structure may include a table. Creating the data structure entry corresponding to the webpage access may include creating a category inheriting table entry in a case that the webpage access is via a linking webpage, creating a category inheriting table entry in a case that the webpage access is via a linking webpage in a separate tab or window, or creating a non-inheriting table entry in a case that the webpage access is without a linking webpage.

Creating the data structure entry corresponding to the webpage access may include creating a table entry in a table in a case that the webpage access is via a linking webpage. Creating the data structure entry corresponding to the webpage access may include creating a table entry in a new table in a case that the webpage access is via a linking webpage in a separate tab or window or creating a table entry in a separate table in a case that the webpage access is without a linking webpage.

An electronic device for webpage bookmark categorization is also described. The electronic device includes a processor. The processor is configured to determine to add a bookmark for a webpage. The processor is also configured to access a linking navigation history. The processor is further configured to determine at least one bookmark category of at least one linking webpage based on the linking navigation history or of at least one link on the webpage. The processor is additionally configured to add a bookmark for the webpage in the at least one bookmark category.

A computer-program product for webpage bookmark categorization is also described. The computer-program product includes a non-transitory tangible computer-readable medium with instructions. The instructions include code for causing an electronic device to determine to add a bookmark for a webpage. The instructions also include code for causing the electronic device to access a linking navigation history. The instructions further include code for causing the electronic device to determine at least one bookmark category of at least one linking webpage based on the linking navigation history or of at least one link on the webpage. The instructions additionally include code for causing the electronic device to add a bookmark for the webpage in the at least one bookmark category.

An apparatus for webpage bookmark categorization is also described. The apparatus includes means for determining to add a bookmark for a webpage. The apparatus also includes means for accessing a linking navigation history. The apparatus further includes means for determining at least one bookmark category of at least one linking webpage based on the linking navigation history or of at least one link on the webpage. The apparatus additionally includes means for adding a bookmark for the webpage in the at least one bookmark category.

### BRIEF DESCRIPTION OF THE DRAWINGS

FIG. 1 is a block diagram illustrating one example of an electronic device in which systems and methods for categorizing webpage bookmarks may be implemented;

FIG. 2 is a flow diagram illustrating one configuration of a method for categorizing webpage bookmarks;

FIG. 3 illustrates an example of bookmark categories, where newly added bookmarks are categorized based on previously visited sites;

FIG. 4 is a flow diagram illustrating a more specific configuration of a method for categorizing webpage bookmarks;

FIG. 5 is a flow diagram illustrating another more specific configuration of a method for categorizing webpage bookmarks;

FIG. 6 is a flow diagram illustrating an example of a method for categorizing a bookmark based on a linking navigation history;

FIG. 7 is a flow diagram illustrating an example of a method for categorizing a bookmark based on one or more links on a webpage;

FIG. 8 is a diagram illustrating an example of webpage browsing;

FIG. 9 is a diagram illustrating one example of a linking navigation history data structure in accordance with the example provided in connection with FIG. 8;

FIG. 10 is a diagram illustrating another example of a linking navigation history data structure in accordance with the example provided in connection with FIG. 8;

FIG. 11 is a diagram illustrating another example of a linking navigation history data structure in accordance with the example provided in connection with FIG. 8;

FIG. 12 is a flow diagram illustrating a configuration of a method for categorizing webpage bookmarks based on any linking webpage(s) and/or any link(s) on a webpage;

FIG. 13 is a flow diagram illustrating a configuration of a method for building a linking navigation history; and

FIG. 14 illustrates certain components that may be included within an electronic device configured to implement various configurations of the systems and methods disclosed herein.

### DETAILED DESCRIPTION

The systems and methods disclosed herein relate to categorizing webpage bookmarks (e.g., automated categorization of bookmarks for webpages). Organizing bookmarks can be a tedious task especially if a user bookmarks may pages. Often, browsers allow categorization of bookmarks into different folders to help organization, but the categorization is still a manual step.

Some configurations of the systems and methods disclosed herein enable automatically determining a category for a newly added bookmark based on a relationship to previously visited webpages (e.g., websites). For example, on a per tab or session basis, if a webpage (e.g., site) is bookmarked, the category for the bookmark may be determined by examining a history of previously visited sites (e.g., a linking navigation history). In some approaches, the linking navigation history may indicate one or more categories for one or more webpages, root addresses, and/or links. These categories may be utilized to automatically categorize a bookmark for a webpage and/or to provide suggestions to a user for categorization. For example, if a webpage to be bookmarked was navigated to from another webpage in the linking navigation history, the new bookmark may be categorized in the corresponding category from the linking navigation history.

It should be noted that the linking webpage may be one or more steps away in the linking navigation history from the webpage to be bookmarked. For example, if it is determined to bookmark a webpage, the linking navigation history may be traversed to determine whether any linking webpage in a chain of pages is categorized. If any linking webpage is categorized, then the new bookmark may be categorized under one or more of the linking webpage categories.

In some approaches, if a webpage includes one or more links to webpages (and/or webpage roots) that are categorized, the new bookmark may be categorized in the category corresponding to the link(s). It should be noted that foregoing approaches may be combined in some configurations. For example, the linking webpage(s) and/or the links on a webpage to be bookmarked may be examined to determine one or more categories for a bookmark of the webpage.

The systems and methods disclosed herein may make it easier to organize bookmarks. Additionally or alternatively, the systems and methods disclosed herein may enable finding useful bookmarks faster.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

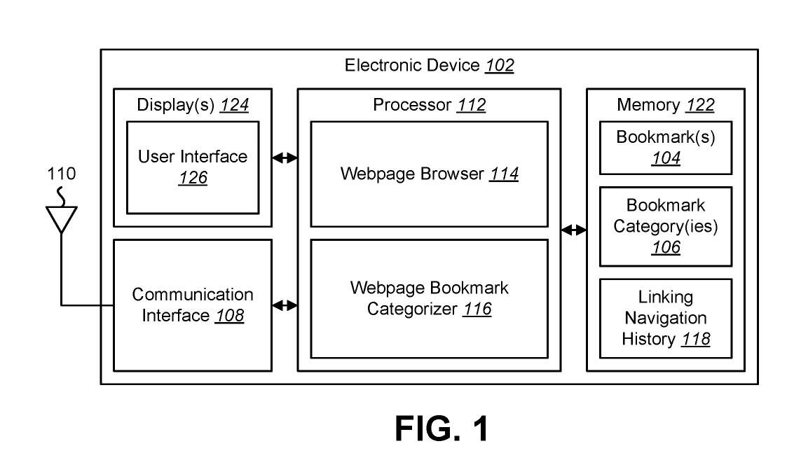

FIG. 1 is a block diagram illustrating one example of an electronic device 102 in which systems and methods for categorizing webpage bookmarks may be implemented. Examples of the electronic device 102 include computers (e.g., desktop computers, laptop computers, etc.), cellular phones, smartphones, tablet devices, media players, televisions, vehicles, cameras, virtual reality devices (e.g., headsets), augmented reality devices (e.g., headsets), mixed reality devices (e.g., headsets), gaming consoles, personal digital assistants (PDAs), set-top boxes, appliances, etc. The electronic device 102 may include one or more components or elements. One or more of the components or elements may be implemented in hardware (e.g., circuitry) or a combination of hardware and software and/or firmware (e.g., a processor with instructions).

In some configurations, the electronic device 102 may include a processor 112, a memory 122, one or more displays 124, and/or a communication interface 108. The processor 112 may be coupled to (e.g., in electronic communication with) the memory 122, display 124, and/or communication interface 108. The processor 112 may be a general-purpose single- or multi-chip microprocessor (e.g., an advanced reduced instruction set computing (RISC) machine (ARM)), a special-purpose microprocessor (e.g., a digital signal processor (DSP)), a microcontroller, a programmable gate array, etc. The processor 112 may be referred to as a central processing unit (CPU). Although just a single processor 112 is shown in the electronic device 102, in an alternative configuration, a combination of processors (e.g., an ARM and a DSP, etc.) could be used. The processor 112 may be configured to implement one or more of the methods disclosed herein.

The memory 122 may store instructions for performing operations by the processor 112. The memory 122 may be any electronic component capable of storing electronic information. The memory 122 may be embodied as random access memory (RAM), read-only memory (ROM), magnetic disk storage media, optical storage media, flash memory devices in RAM, on-board memory included with the processor, EPROM, EEPROM, registers, and so forth, including combinations thereof.

Data and/or instructions may be stored in the memory 122. The instructions may be executable by the processor 112 to implement one or more of the methods described herein. Executing the instructions may involve the use of the data that is stored in the memory 122. When the processor 112 executes the instructions, various portions of the instructions may be loaded onto the processor 112, and various pieces of data may be loaded onto the processor 112.

The processor 112 may access (e.g., read from and/or write to) the memory 122. Examples of instructions and/or data that may be stored by the memory 122 may include one or more bookmarks 104, one or more bookmark categories 106, a linking navigation history 118, webpage browser 114 instructions, and/or webpage bookmark categorizer 116 instructions, etc.

In some configurations, the electronic device 102 may present a user interface 126 on the display 124. For example, the user interface 126 may enable a user to interact with the electronic device 102. For example, the user interface 126 may receive a touch, a mouse click, a gesture and/or some other input indicates a command or request.

The display(s) 124 may be integrated into the electronic device 102 and/or may be coupled to the electronic device 102. For example, the electronic device 102 may be a smartphone with an integrated display. In another example, the electronic device 102 may be coupled to one or more remote displays 124 and/or to one or more remote devices that include one or more displays 124.

The communication interface 108 may enable the electronic device 102 to communicate with one or more other electronic devices. For example, the communication interface 108 may provide an interface for wired and/or wireless communications. In some configurations, the communication interface 108 may be coupled to one or more antennas 110 for transmitting and/or receiving radio frequency (RF) signals. Additionally or alternatively, the communication interface 108 may enable one or more kinds of wireline (e.g., Universal Serial Bus (USB), Ethernet, etc.) communication. The communication interface 108 may be linked to one or more electronic devices (e.g., routers, modems, switches, servers, etc.). For example, the communication interface 108 may enable network (e.g., personal area network (PAN), local area network (LAN), metropolitan area network (MAN), wide area network (WAN), Internet, and/or public switched telephone network (PSTN), etc.) communications.

In some configurations, multiple communication interfaces 108 may be implemented and/or utilized. For example, one communication interface 108 may be a cellular (e.g., 3G, Long Term Evolution (LTE), CDMA, etc.) communication interface 108, another communication interface 108 may be an Ethernet interface, another communication interface 108 may be a universal serial bus (USB) interface, and yet another communication interface 108 may be a wireless local area network (WLAN) interface (e.g., Institute of Electrical and Electronics Engineers (IEEE) 802.11 interface). In some configurations, the communication interface 108 may send information (e.g., webpage requests, upload data, etc.) to and/or receive information from another device (e.g., another electronic device, a computer, a remote server, etc.). The communication interface 108 may utilize one or more protocols (e.g., transmission control protocol (TCP), Internet protocol (IPv4, IPv6, etc.), hypertext transfer protocol (HTTP), etc.) for communication.

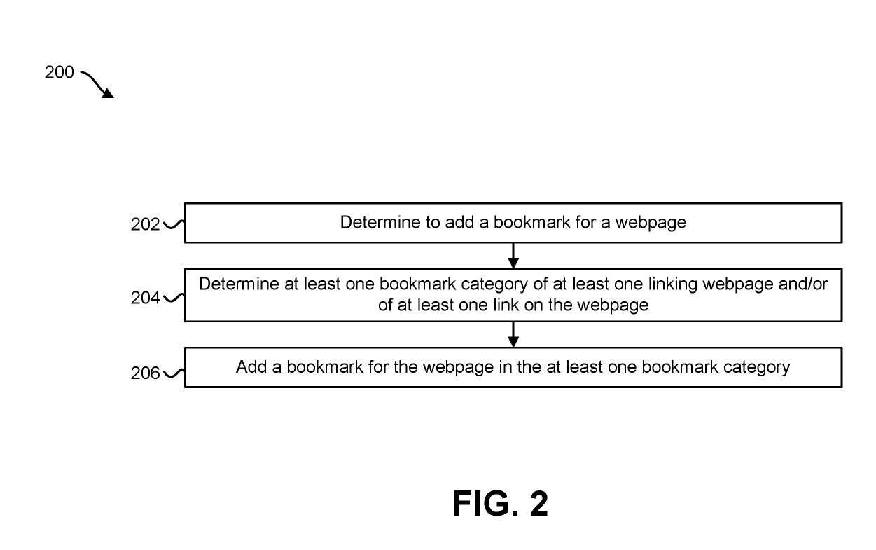

In some configurations, the electronic device 102 may perform one or more of the functions, procedures, methods, steps, etc., described in connection with one or more of FIGS. 2-14. Additionally or alternatively, the electronic device 102 may include one or more of the structures described in connection with one or more of FIGS. 2-14.

The processor 112 may include and/or implement a webpage browser 114. The webpage browser 114 may be an application (e.g., program) that enables accessing one or more webpages. The webpage browser 114 may request and/or receive information (e.g., data) from one or more remote devices (via the communication interface 108, for example). For instance, the webpage browser 114 may request and/or receive one or more webpages (e.g., webpage data, website data, etc.) from one or more remote devices (e.g., web servers, computers, etc.). A webpage may have a corresponding address (e.g., network address, web address, Internet address, uniform resource locator (URL), etc.).

A webpage may include one or more kinds of information. For example, a webpage may include text, one or more images, one or more videos, one or more links (e.g., hyperlinks), and/or one or more objects (e.g., fields, text boxes, buttons, frames, sliders, lists, tables, etc.), etc. A link may include a reference to an address (e.g., network address, web address, Internet address, URL, etc.). For example, webpage content (e.g., text, image(s), video(s), objects, etc.) may be hyperlinked with a link. In some approaches, hyperlinked content may be highlighted and/or may cause a cursor to change on hovering over hyperlinked content to indicate a link.

In some configurations, a webpage may be formatted and/or coded in accordance with one or more languages (e.g., hypertext markup language (HTML), extensible markup language (XML), extensible hypertext markup language (XHTML), JavaScript, cascading style sheets (CSS), etc.). In some approaches, the webpage browser 114 may process (e.g., render) the webpage(s) and/or present the webpage(s) on the display(s) 124.

In some configurations, the electronic device 102 may present a user interface 126 on the display 124. The user interface 126 may enable a user to interact with the electronic device 102. For example, the user interface 126 may receive a touch, a mouse click, a gesture, a keypad input, a keyboard input, and/or some other input that indicates interaction with the electronic device 102.

In some configurations, the webpage browser 114 may produce and/or provide the user interface 126. For example, the user interface 126 may enable a user to interact with a webpage. For instance, the user interface 126 may receive a touch, a mouse click, a gesture, a keypad input, a keyboard input, and/or some other input that indicates interaction with the webpage. A received input may indicate a command for the webpage browser 114 to follow a link on a webpage. For example, the user interface 126 may receive a click or touch (e.g., tap) corresponding to a link (e.g., hyperlinked content) on a webpage, which may indicate a command to browse to the address of a link.

The webpage browser 114 may browse to the address of a link (e.g., request and/or receive information for a webpage at the link address). Accordingly, a webpage may be accessed via one or more links (e.g., a sequence or chain of links). Any webpage that includes a link (in the sequence or chain of links, for example) that is used (in a browsing session, for example) to browse to a webpage may be a “linking webpage” with respect to the webpage.

In some instances, the webpage browser 114 may browse to one or more webpages without the use of a link. This may be referred to as “non-link” browsing. For example, the webpage browser 114 may receive (via the user interface 126 and/or the communication interface 108, for example) an address for browsing. For instance, the webpage browser 114 may receive a keyboard and/or touchscreen input that indicates a URL (e.g., http://webpageURLexample.com). Accordingly, the webpage browser 114 may browse to a webpage with non-link browsing. In some cases, the webpage browser 114 may browse to an initial webpage with non-link browsing and/or to one or more subsequent webpages with non-link browsing. For example, although a first webpage is browsed to via a link, a second webpage may be browsed to with non-link browsing. Non-link browsing may end a sequence (e.g., break a chain) of linking webpages with respect to the webpage accessed with non-link browsing.

In some configurations, the webpage browser 114 may enable and/or provide tabbed browsing and/or windowed browsing. Tabbed and/or windowed browsing may allow for multiple webpages to be accessed, presented, and/or handled concurrently. For example, a first webpage may be accessed and/or presented in a first tab, while a second webpage may be accessed and/or presented in a second tab. Additionally or alternatively, a first webpage may be accessed and/or presented in a first window, while a second webpage may be accessed and/or presented in a second window.

In some implementations, the webpage browser 114 may allow opening a webpage in a tab (or window) from a link on a webpage in another tab (or another window). For example, a first tab may include a first webpage that includes a link. The webpage browser 114 may open a second webpage in a second tab with the link from the first webpage in the first tab. Additionally or alternatively, the webpage browser 114 may open a second webpage in a second window with the link from a first webpage in a first window.

In some approaches, a link may be opened in a new tab (or a new window) based on a received input. For example, the received input may indicate a command to open a link in a new tab (when a control key is depressed with a click on hyperlinked content, a right-click list command indicating opening the link in a new tab, etc., for instance). In another example, the received input may indicate a command to open a link in a new window (when a shift key is depressed with a click on hyperlinked content, a right-click list command indicating opening the link in a new window, etc., for instance).

The processor 112 (e.g., webpage browser 114, webpage bookmark categorizer 116, etc.) may create a linking navigation history 118. The linking navigation history 118 may be stored in memory 122. The linking navigation history 118 may indicate whether navigation (e.g., browsing) to a webpage was accomplished with one or more links (e.g., linking) or without a link (e.g., linking). For example, the linking navigation history 118 may indicate one or more linking webpages (e.g., a sequence or chain of links) corresponding to a webpage. In some configurations, the linking navigation history 118 may be created while the webpage browser 114 browses to (e.g., accesses) one or more webpages. Creating the linking navigation history 118 may include updating a linking navigation history 118.

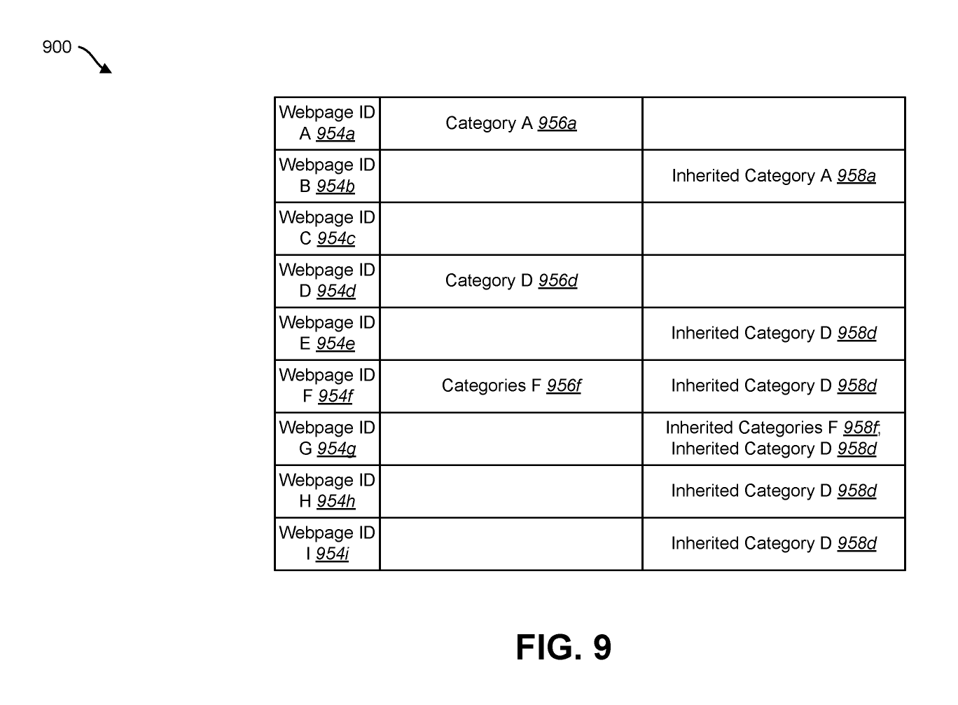

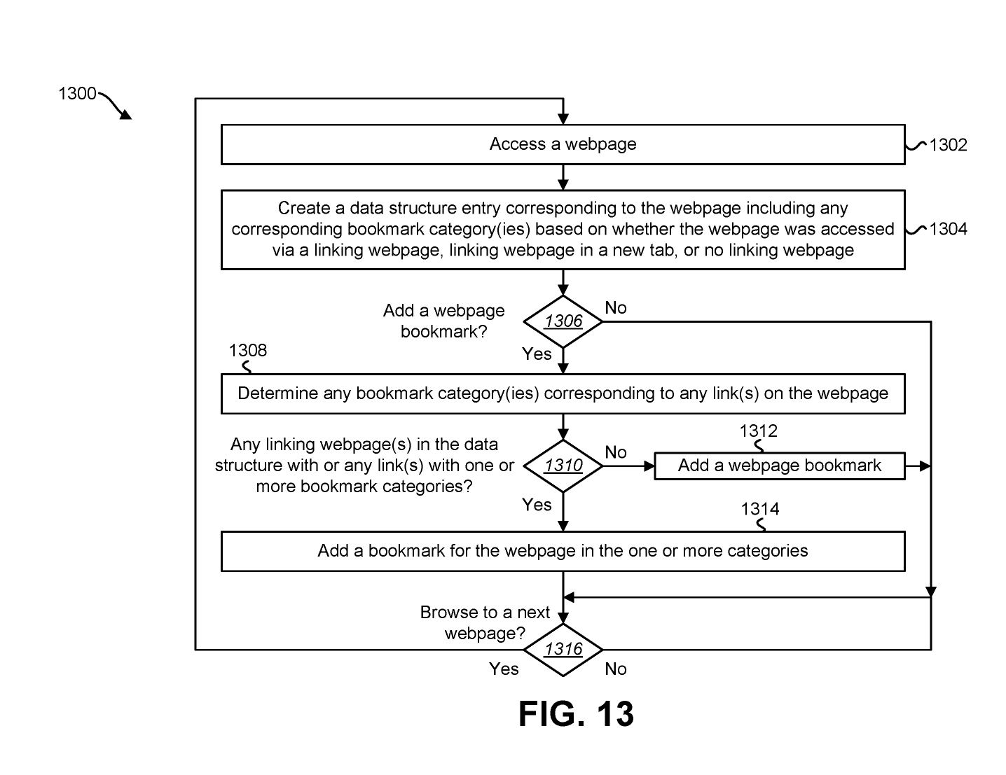

Creating the linking navigation history 118 may include creating a linking navigation history data structure. For instance, the processor 112 (e.g., webpage browser 114, webpage bookmark categorizer 116, etc.) may create a data structure entry for each webpage that is accessed (e.g., requested and/or received) in a browsing session. Examples of linking navigation history data structures may include tables, trees, lists, linked lists, arrays, heaps, stacks, etc. FIGS. 9-11 provide some examples of linking navigation history data structures. FIG. 13 provides an example of creating the linking navigation history.

It should be noted that the memory 122 may store a browsing history in some configurations. A browsing history may be a record of one or more webpages that the webpage browser 114 has accessed. For example, a browsing history may indicate a list of webpages (e.g., URLs) accessed by the webpage browser 114 (with corresponding times, for instance). In some configurations, a browsing history alone may not indicate whether navigation to a webpage was accomplished with or without one or more links. It should be noted that the linking navigation history 118 may be associated with, may be integrated into, and/or may be based on the browsing history in some configurations. In other configurations, the linking navigation history 118 may be independent from the browsing history.

A webpage bookmark (or simply a “bookmark”) may be an indicator of a particular webpage (e.g., webpage address). For example, a bookmark may be created in order to record a webpage address and/or to facilitate subsequent access of the webpage. One or more bookmarks 104 may be stored in memory 122. The processor 112 (e.g., webpage browser 114, webpage bookmark categorizer 116, etc.) may create (e.g., determine, generate, store, etc.) the bookmark(s) 104.

In some configurations, a bookmark may be created based on a received input. For example, the processor 112 (e.g., webpage browser 114, webpage bookmark categorizer 116, etc.) may receive an input via the user interface 126 indicating a command to create a bookmark 104 for one or more webpages. For instance, the processor 112 may receive a click or tap event on a button for the user interface 126 of the webpage browser 114 that indicates a command to create a bookmark 104 for a webpage (e.g., a webpage that is currently being presented by the webpage browser 114). Additionally or alternatively, the processor 112 (e.g., webpage browser 114, webpage bookmark categorizer 116, etc.) may automatically create a bookmark 104 (without a received input explicitly commanding bookmark creation, for example). For example, the processor 112 may automatically create a bookmark 104 for a webpage that has been accessed at least a threshold number of accesses, accessed at least a threshold number of accesses within a period of time, accessed with at least a threshold frequency, accessed for at least a threshold amount of time, etc.

The processor 112 may include and/or implement a webpage bookmark categorizer 116. The webpage bookmark categorizer 116 may categorize one or more webpage bookmarks. For example, the webpage bookmark categorizer 116 may associate one or more bookmarks 104 with one or more bookmark categories 106. The bookmark category(ies) 106 may be stored in memory 122. The bookmark category(ies) 106 may be structured in accordance with one or more approaches. In one approach, for example, a bookmark category 106 may be a folder in which the bookmark(s) 104 may be stored. In another approach, a bookmark category 106 may be a tag that may be associated with each bookmark 104 in that bookmark category 106. In yet another approach, a bookmark category 106 may be a data structure (e.g., a column or row in a table, an array, etc.) that includes the bookmark(s) 104 (e.g., bookmark tag(s), bookmark addresses, etc.) in the data structure. Other approaches may be implemented.

In some configurations, the webpage bookmark categorizer 116 may create one or more of the bookmark category(ies) 106 based on a received input. For example, the webpage bookmark categorizer 116 may receive an input (via the user interface 126, for example) indicating a command to create a bookmark category 106. For instance, the webpage bookmark categorizer 116 may receive an input indicating a command to create a bookmark category 106 with a name (indicated via keyboard, touch input, speech recognition, etc.). In some configurations, one or more bookmark categories 106 may not exist initially and/or may not be associated with any bookmark(s) 104 initially. For example, the bookmark category(ies) 106 may only be created and/or associated with bookmark(s) 104 when indicated by a received input (e.g., user input).

Additionally or alternatively, one or more of the bookmark category(ies) 106 may be predetermined. For example, the bookmark category(ies) 106 may include one or more default bookmark categories. The one or more default bookmark categories may not be associated with any bookmark(s) 104 initially. Alternatively, the one or more default bookmark categories may be associated with a predetermined set of bookmark(s) 104 (e.g., popular news sites may be associated with a news category, popular video sites may be associated with a video category (and/or entertainment category), popular banking sites may be associated with a money category, etc.).

It should be noted that a bookmark 104 may be allowed to be associated with multiple bookmark categories 106 in some configurations. In other configurations, each bookmark 104 may only be allowed to be associated with one bookmark category 106. In yet other configurations, the number of categories 106 allowed to be associated with a bookmark 104 may be configurable (based on a user preference and/or input, for example) to be one or another number.

The webpage bookmark categorizer 116 may determine a bookmark category 106 for a webpage. In some configurations, the webpage bookmark categorizer 116 may determine a bookmark category of at least one linking webpage. For example, the webpage bookmark categorizer 116 may determine one or more bookmark categories 106 of any linking webpage(s) (relative to a webpage, for instance). The webpage bookmark categorizer 116 may add a bookmark 104 for the webpage in the one or more bookmark categories 106. For example, the webpage bookmark categorizer 116 may create a bookmark 104 for a webpage and/or associate the bookmark 104 for the webpage with one or more bookmark categories 106 corresponding to any (e.g., all) linking webpage(s) of the webpage. It should be noted that a webpage bookmark may be categorized in the category of a bookmark for a linking webpage that is one or more steps away (indicated in the linking navigation history 118, for example).

In some approaches, the webpage bookmark categorizer 116 may categorize a bookmark for a webpage within a number of linking webpages (e.g., one or more). For example, the webpage bookmark categorizer 116 may categorize a bookmark for a webpage in the category of bookmark for a nearest linking webpage (e.g., a webpage with a link utilized to browse to the current webpage). Accordingly, the automatic categorization may be limited to be within a number of linking webpages indicated in the linking navigation history 118, for example.

In some configurations, the webpage bookmark categorizer 116 may access the linking navigation history 118 to determine one or more bookmark categories 106 corresponding to one or more linking webpages. In some approaches, the webpage bookmark categorizer 116 may access at least a portion of a linking navigation history data structure and may categorize a bookmark 104 for the webpage in one or more bookmark categories 106 indicated by the at least a portion of the linking navigation history data structure.

It should be noted that the one or more bookmark categories 106 of linking webpage(s) may be explicitly or implicitly indicated by the linking navigation history 118 (e.g., linking navigation history data structure). For example, the linking navigation history 118 may only implicitly indicate one or more linking webpages of a webpage. To determine the bookmark category(ies) 106 for a bookmark of a webpage, the webpage bookmark categorizer 116 may search for categorized bookmark(s) 104 corresponding to the linking webpage(s) (e.g., the addresses or URLs of the linking webpage(s)) and may categorize the bookmark of the webpage in the bookmark category(ies) 106 corresponding to the bookmark(s) 104 of the linking webpage(s). Alternatively, the linking navigation history 118 may explicitly indicate one or more bookmark categories 106 corresponding to the linking webpage(s). For example, the linking navigation history 118 may store data explicitly indicating one or more bookmark categories 106 and/or references (e.g., pointers) to one or more bookmark categories 106. Accordingly, the webpage bookmark categorizer 116 may categorize the bookmark of the webpage in the bookmark category(ies) 106 of the linking webpage(s) explicitly indicated in the linking navigation history 118.

In some configurations, the linking navigation history 118 may be created, maintained, updated, and/or stored during a browsing session. For example, while a webpage browser 114 is open and/or accesses one or more webpages, the linking navigation history 118 may be created, maintained, updated, and/or stored. In some approaches, the linking navigation history 118 may be discarded when a browsing session ends (e.g., when the webpage browser 114 is closed).

In some configurations (in addition to or alternatively from the aforementioned linking webpage techniques), the webpage bookmark categorizer 116 may determine one or more bookmark categories 106 of one or more links on the webpage. For example, the webpage bookmark categorizer 116 may search the webpage for links (e.g., links corresponding to hyperlinked content). The webpage bookmark categorizer 116 may determine a bookmark category corresponding to one or more links on the webpage. In some approaches, webpage bookmark categorizer 116 may search for categorized bookmark(s) 104 corresponding to the links (e.g., the addresses or URLs of the link(s)) on the webpage. The webpage bookmark categorizer 116 may categorize the bookmark of the webpage in the bookmark category(ies) 106 corresponding to the bookmark(s) 104 of the link(s).

In some approaches, link(s) on a webpage and/or bookmark category(ies) corresponding to the link(s) may be stored in the linking navigation history 118. For example, the link(s) and/or corresponding bookmark category(ies) (or indicators thereof) may be stored in one or more data structures in the linking navigation history 118. For example, the link(s) and/or corresponding bookmark category(ies) may be stored in or associated with one or more entries (e.g., nodes) of the linking navigation history 118 corresponding to one or more webpages. For instance, link(s) on a webpage and/or corresponding bookmark category(ies) may be added to an entry (e.g., node) of a data structure when the webpage is accessed. Accordingly, the electronic device 102 (e.g., processor 112, webpage browser 114 and/or webpage bookmark categorizer 116) may utilize the linking navigation history 118 to determine link(s) and/or bookmarking category(ies) corresponding to link(s) in some configurations.

In some approaches, link(s) on a webpage and/or bookmark category(ies) corresponding to the link(s) may not be stored in the linking navigation history 118. For example, link(s) and/or corresponding bookmark category(ies) may be determined from a webpage for bookmarking.

It should be noted that one or more of the elements or components of the electronic device 102 may be combined and/or divided. For example, the webpage browser 114 and/or the webpage bookmark categorizer 116 may be combined. Additionally or alternatively, one or more of the webpage browser 114 and/or the webpage bookmark categorizer 116 may be divided into elements or components that perform a subset of the operations thereof.

FIG. 2 is a flow diagram illustrating one configuration of a method 200 for categorizing webpage bookmarks. The method 200 may be performed by one or more of the electronic devices described herein (e.g., the electronic device 102 described in connection with FIG. 1). The electronic device 102 may determine 202 to add a bookmark for a webpage. This may be accomplished as described in connection with FIG. 1. For example, the electronic device 102 may receive an input indicating a command to add a bookmark for a webpage. Additionally or alternatively, the electronic device 102 may determine 202 to add a bookmark for a webpage automatically (if the webpage has been accessed at least a threshold number of accesses, etc.).

The electronic device 102 may determine 204 at least one bookmark category of at least one linking webpage and/or of at least one link on the webpage. This may be accomplished as described in connection with FIG. 1. For example, the electronic device 102 may determine one or more bookmark categories of one or more linking webpages in the linking navigation history. Additionally or alternatively, the electronic device 102 may determine one or more bookmark categories corresponding to one or more links on the webpage.

The electronic device 102 may add 206 a bookmark for the webpage in at least one bookmarking category. This may be accomplished as described in connection with FIG. 1. For example, the electronic device 102 may create a bookmark for the webpage and/or associate a bookmark for the webpage with one or more bookmarking categories of the one or more linking webpages and/or of the one or more links on the page.

In some configurations, the electronic device 102 may present the bookmark for the webpage in the bookmarking category(ies). For example, the electronic device 102 (e.g., webpage browser 114, webpage bookmark categorizer 116) may present the bookmark in the bookmarking category(ies) on the display(s) 124. For instance, the webpage browser 114 may present a set (e.g., list) of bookmarking categories (when an input is received indicating a request for bookmarking categories). The bookmark may be presented in the one or more associated bookmarking categories. In some configurations and/or instances, the electronic device 102 may receive an input indicating selection of the bookmark. The electronic device 102 (e.g., webpage browser 114) may access (e.g., request and/or receive) the webpage corresponding to the bookmark.

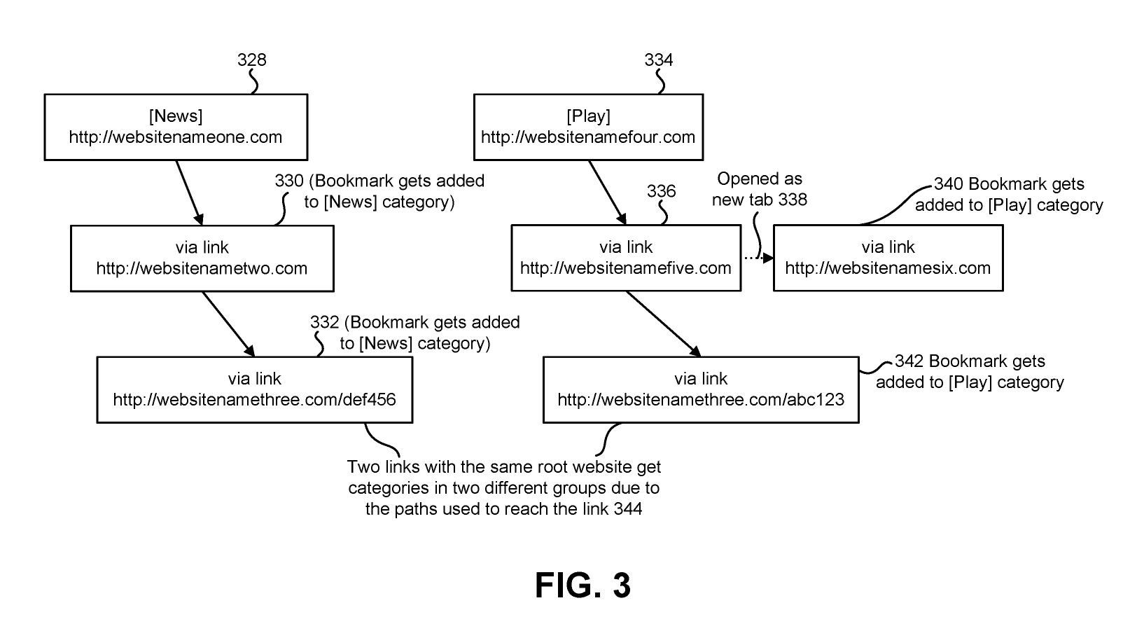

FIG. 3 illustrates an example of bookmark categories, where newly added bookmarks are categorized based on previously visited sites. In particular, FIG. 3 illustrates a first webpage 328 at http://websitenameone.com. The first webpage 328 has a bookmark in a news category. In this example, a second webpage 330 at http://websitenametwo.com is navigated to via a link from the first webpage 328. Accordingly, the first webpage 328 is a linking webpage relative to the second webpage 330. As illustrated in FIG. 3, a bookmark for the second webpage 330 would be added in the news category, since the first webpage 328 (a linking webpage) has a corresponding news category.

In this example, a third webpage 332 at http://websitenamethree.com/def456 is navigated to via a link from the second webpage 330. Accordingly, the first webpage 328 and the second webpage 330 are linking webpages relative to the third webpage 332. As illustrated in FIG. 3, a bookmark for the third webpage 332 would be added in the news category, since the first webpage 328 or the second webpage 330 (a linking webpage) has a corresponding news category.

Additionally, FIG. 3 illustrates a fourth webpage 334 at http://websitenamefour.com. The fourth webpage 334 has a bookmark in a play category. In this example, a fifth webpage 336 at http://websitenamefive.com is navigated to via a link from the fourth webpage 334. Accordingly, the fourth webpage 334 is a linking webpage relative to the fifth webpage 336.

In this example, a sixth webpage 340 at http://websitenamesix.com is opened in a new tab 338 via a link from the fifth webpage 336. Accordingly, the fourth webpage 334 and the fifth webpage 336 are linking webpages relative to the sixth webpage 340. As illustrated in FIG. 3, a bookmark for the sixth webpage 340 would be added in the play category, since the fourth webpage 334 (a linking webpage) has a corresponding play category.

In this example, a seventh webpage 342 at http://websitenamethree.com/abc123 is navigated to via a link from the fifth webpage 336. Accordingly, the fourth webpage 334 and the fifth webpage 336 are linking webpages relative to the seventh webpage 342. As illustrated in FIG. 3, a bookmark for the seventh webpage 342 would be added in the play category, since the fourth webpage 334 (a linking webpage) has a corresponding play category.

As illustrated in the example in FIG. 3, two links with the same root website may get different categories in two different groups due to the paths used to reach the link 344. For example, a webpage bookmark may not be categorized simply according to a category of a root address. Accordingly, different webpages with the same root address may have different categories if they are reached via different paths with linking webpages of different bookmark categories.

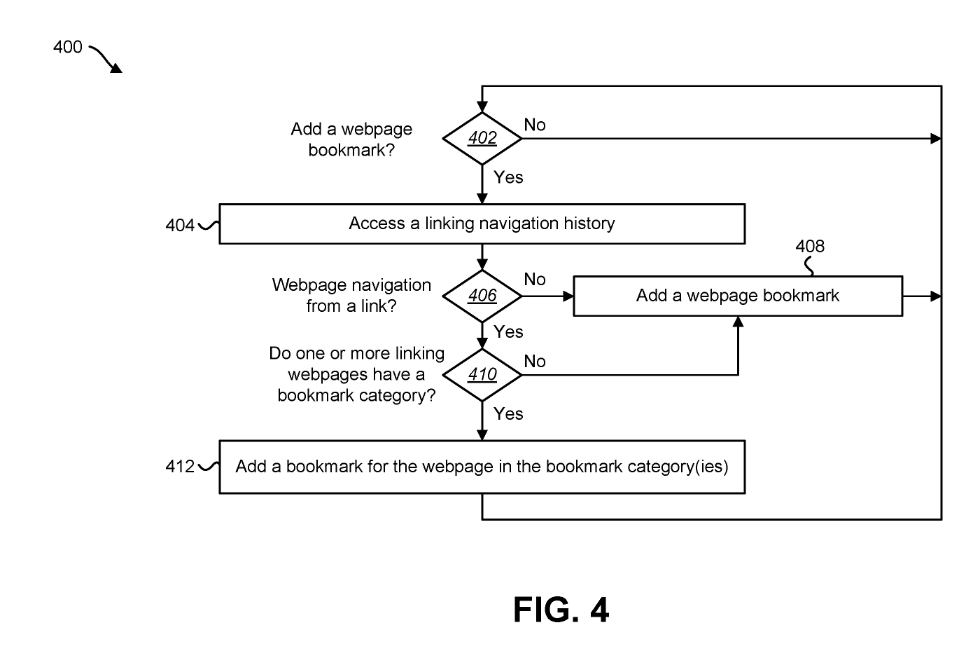

FIG. 4 is a flow diagram illustrating a more specific configuration of a method 400 for categorizing webpage bookmarks. The method 400 may be performed by one or more of the electronic devices described herein (e.g., the electronic device 102 described in connection with FIG. 1). The electronic device 102 may determine 402 whether to add a bookmark for a webpage. This may be accomplished as described in connection with one or more of FIGS. 1-2. For example, in a case that the electronic device 102 does not receive an input indicating a command to add a bookmark for a webpage, the electronic device 102 may determine 402 to not add a bookmark. Additionally or alternatively, the electronic device 102 may determine 402 to not add a bookmark for a webpage automatically (if the webpage has not been accessed at least a threshold number of accesses, etc.). As illustrated in FIG. 4, the electronic device 102 may wait until it is determined 402 to add a bookmark for a webpage.

In a case that the electronic device 102 determines 402 to add a webpage bookmark (e.g., receives an input indicating a command to add a bookmark for a webpage and/or determines to add a bookmark for a webpage automatically (if the webpage has been accessed at least a threshold number of accesses, etc.)), the electronic device 102 may access 404 a linking navigation history 118. For example, the electronic device 102 may read the linking navigation history 118 relative to the current webpage.

The electronic device 102 may determine 406 whether the webpage navigation is from a link (e.g., whether the webpage has any linking webpage(s)). For example, the electronic device 102 may determine 406 whether the webpage (e.g., the current webpage) was navigated to from one or more links (in a sequence or chain of links, for instance). In some approaches, link navigation may be indicated in the linking navigation history 118. For example, the link navigation history 118 may include data that indicates whether the webpage was navigated to from a link. For instance, the link navigation history 118 may include an entry for each webpage in a browsing session. The entry may include data that (explicitly) indicates whether the webpage was navigated to from a link (or not). Additionally or alternatively, the arrangement of the link navigation history 118 may indicate whether the webpage was navigated to from a link (or not). For example, if an entry in the linking navigation history of the webpage does not have a parent webpage node (e.g., if the parent node is a root node) or if the entry is does not have a preceding entry in a table, the electronic device 102 may determine that the webpage was not navigated to from a link.

If the electronic device 102 determines 406 that the webpage navigation was not from a link, then the electronic device 102 may add 408 a webpage bookmark. For example, the electronic device 102 may create a bookmark for the webpage (e.g., store a bookmark 104 in memory 122). The bookmark may or may not be categorized. For example, the bookmark may not be associated with any category. In another example, the bookmark may be categorized in an “all” category by default.

In some configurations, the electronic device 102 may determine whether to categorize the bookmark for the webpage. For example, the electronic device 102 may present a prompt (on the display 124, for instance). The prompt may query whether to categorize the bookmark in an existing category and/or whether to create a new category for the bookmark. If the electronic device 102 receives an input indicating a command to categorize the bookmark, the electronic device 102 may categorize the bookmark in a category indicated by the input, in a default category, and/or in a new category specified by the input. Additionally or alternatively, the electronic device 102 may automatically categorize the bookmark (e.g., automatically categorize the bookmark in a default category (e.g., an “all” category), automatically select an existing category based on webpage content, etc.).

If the electronic device 102 determines 406 that the webpage navigation is (or was) from a link, the electronic device 102 may determine 410 whether one or more linking webpages have a bookmark category. For example, the electronic device 102 may determine 410 whether the one or more linking webpages have a bookmark category based on the linking navigation history. This may be accomplished as described in connection with FIG. 1. For instance, the one or more bookmark categories 106 of linking webpage(s) may be explicitly or implicitly indicated by the linking navigation history 118 as described herein. In some approaches, to determine the bookmark category(ies) 106 for a bookmark of a webpage, the webpage bookmark categorizer 116 may search for categorized bookmark(s) 104 corresponding to the linking webpage(s) (e.g., the addresses or URLs of the linking webpage(s)). Alternatively, the linking navigation history 118 may explicitly indicate one or more bookmark categories 106 corresponding to the linking webpage(s).

In a case that none of the one or more linking webpages have a bookmark category, the electronic device 102 may add 408 a webpage bookmark (as described above, for example). In a case that one or more linking webpages have a bookmark category, the electronic device 102 may add 412 a bookmark for the webpage in the bookmark category(ies). In particular, the bookmark for the webpage may be categorized in (e.g., associated with) the bookmark category(ies) corresponding to one or more linking webpages. For example, the electronic device 102 may tag the bookmark with the category(ies) of the one or more linking webpages (e.g., linking webpage bookmark(s)), may store the bookmark in the category(ies) of the one or more linking webpages (e.g., linking webpage bookmark(s)), etc.

In some configurations, determining 406 whether webpage navigation is from a link and determining 410 whether one or more linking webpages have a bookmark category may be combined. For example, some configurations of the linking navigation history may inherit one or more potential bookmark categories from linking webpages in an entry corresponding to the webpage. Accordingly, the electronic device 102 may examine the webpage entry itself to determine both whether webpage navigation is from a link and whether one or more linking webpages have a bookmark category. For example, the absence of any inherited category may indicate either that webpage navigation was not from a link or that there is no bookmark category from a linking webpage. However, the presence of an inherited category may indicate both that webpage navigation was from a link and that a linking webpage has a bookmark category (which may be utilized as the bookmark category for the webpage).

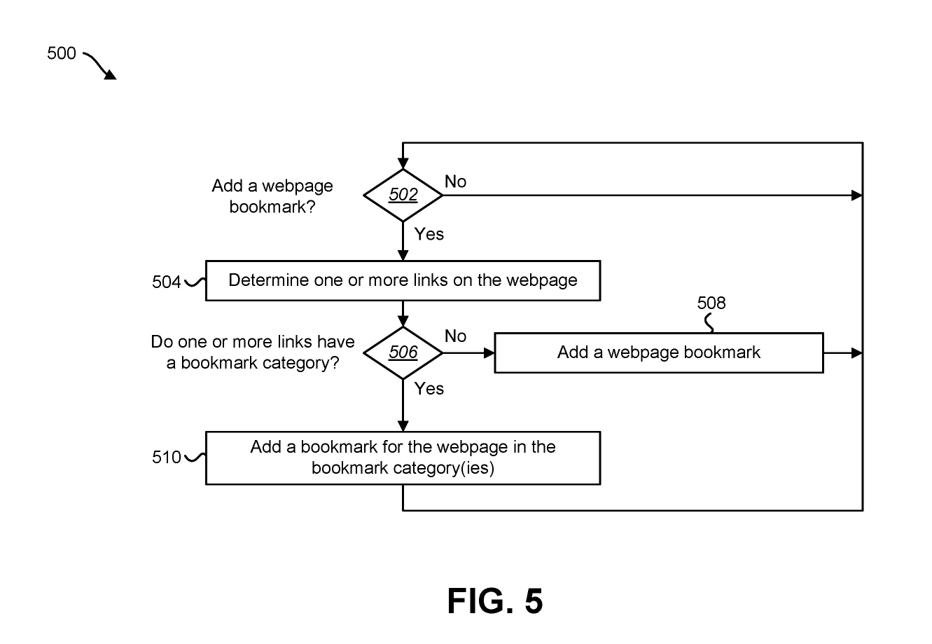

FIG. 5 is a flow diagram illustrating another more specific configuration of a method 500 for categorizing webpage bookmarks. The method 500 may be performed by one or more of the electronic devices described herein (e.g., the electronic device 102 described in connection with FIG. 1). In the approach described in connection with FIG. 5, a webpage to be bookmarked may be examined to determine whether any of the links on the webpage (e.g., any webpage(s) corresponding to the link(s)) have a categorized bookmark. If one or more of the links have a categorized bookmark, the new bookmark may be categorized in one or more categories corresponding to the link(s) (and/or to the root of the link(s)).

The electronic device 102 may determine 502 whether to add a bookmark for a webpage. This may be accomplished as described in connection with one or more of FIGS. 1-2 and 4. For example, in a case that the electronic device 102 does not receive an input indicating a command to add a bookmark for a webpage, the electronic device 102 may determine 502 to not add a bookmark. Additionally or alternatively, the electronic device 102 may determine 502 to not add a bookmark for a webpage automatically (if the webpage has not been accessed at least a threshold number of accesses, etc.). As illustrated in FIG. 5, the electronic device 102 may wait until it is determined 502 to add a bookmark for a webpage.

In a case that the electronic device 102 determines 502 to add a webpage bookmark (e.g., receives an input indicating a command to add a bookmark for a webpage and/or determines to add a bookmark for a webpage automatically (if the webpage has been accessed at least a threshold number of accesses, etc.)), the electronic device 102 may determine 504 one or more links on the webpage. This may be accomplished as described in connection with FIG. 1. For example, the electronic device 102 may search the webpage for one or more links (e.g., links corresponding to hyperlinked content). For instance, the electronic device 102 may search the webpage for hyperlink elements and/or functions (e.g., HTML “<a>” elements, HTML “<a>” elements with “href” attributes, JavaScript “link( )” methods, etc.). The electronic device 102 may determine one or more links (e.g., addresses, URLs, etc.) corresponding to the hyperlink elements and/or functions.

The electronic device 102 may determine 506 whether one or more links have a bookmark category. This may be accomplished as described in connection with FIG. 1. For example, the electronic device 102 may search for categorized bookmark(s) 104 corresponding to the links (e.g., the addresses or URLs of the link(s)) on the webpage.

If the electronic device 102 determines 506 that none of the one or more links have a bookmark category, the electronic device 102 may add 508 a webpage bookmark. This may be accomplished as described in connection with FIG. 4. For example, the electronic device 102 may create a bookmark for the webpage (e.g., store a bookmark 104 in memory 122). The bookmark may or may not be categorized. For example, the bookmark may not be associated with any category. In another example, the bookmark may be categorized in an “all” category by default.

In some configurations, the electronic device 102 may determine whether to categorize the bookmark for the webpage. For example, the electronic device 102 may present a prompt (on the display 124, for instance). The prompt may query whether to categorize the bookmark in an existing category and/or whether to create a new category for the bookmark. If the electronic device 102 receives an input indicating a command to categorize the bookmark, the electronic device 102 may categorize the bookmark in a category indicated by the input, in a default category, and/or in a new category specified by the input. Additionally or alternatively, the electronic device 102 may automatically categorize the bookmark (e.g., automatically categorize the bookmark in a default category (e.g., an “all” category), automatically select an existing category based on webpage content, etc.).

In a case that the one or more links have a bookmark category, the electronic device 102 may add 510 a bookmark for the webpage in the bookmark category(ies). In particular, the bookmark for the webpage may be categorized in (e.g., associated with) the bookmark category(ies) corresponding to one or more links. For example, the electronic device 102 may tag the bookmark with the category(ies) of the one or more links (e.g., link bookmark(s)), may store the bookmark in the category(ies) of the one or more links (e.g., link bookmark(s)), etc.

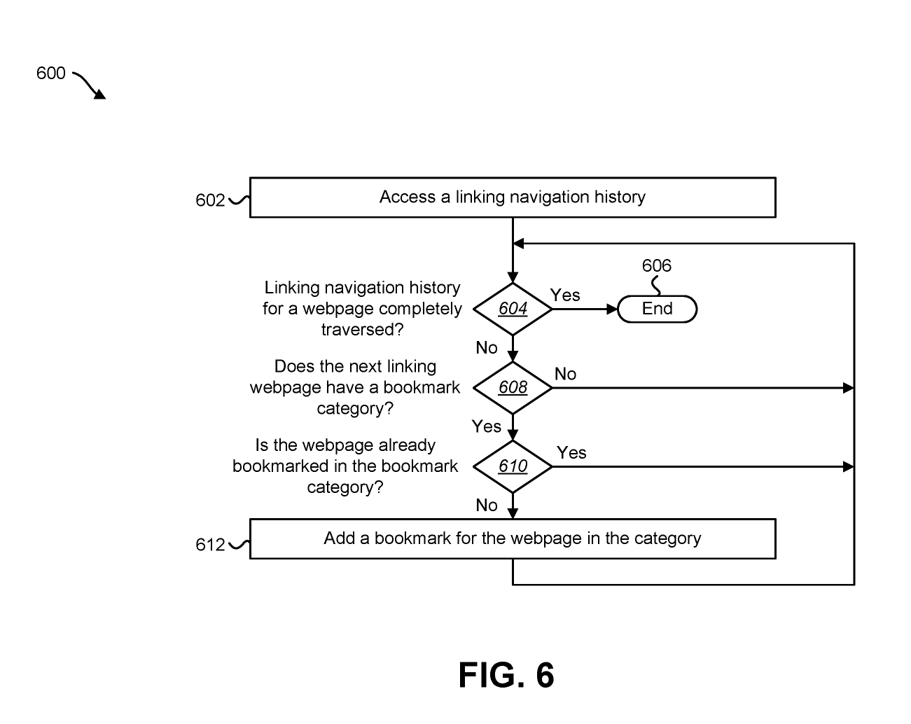

FIG. 6 is a flow diagram illustrating an example of a method 600 for categorizing a bookmark based on a linking navigation history. For instance, the method 600 may be performed in cases where it has been determined to add a bookmark. The method 600 may be performed by one or more of the electronic devices described herein (e.g., the electronic device 102 described in connection with FIG. 1).

The electronic device 102 may access 602 a linking navigation history 118. This may be accomplished as described in connection with one or more of FIGS. 1-2 and 4. For example, the electronic device 102 may read (e.g., retrieve from memory 122) the linking navigation history 118 relative to the current webpage.

The electronic device 102 may determine 604 whether the linking navigation history 118 for a webpage is completely traversed. For example, the electronic device 102 may determine whether at least a portion of the linking navigation history 118 corresponding to a webpage (e.g., the current webpage) has been completely traversed. The portion of the linking navigation history 118 that corresponds to the webpage may differ based on approach. For example, the linking navigation history 118 may include one or more data structures that may differ based on approach. Although some examples of data structures are provided herein, other data structures may be utilized. Examples of linking navigation history data structures may include tables, trees, lists, linked lists, arrays, heaps, stacks, etc. Some examples of data structures are given as follows.

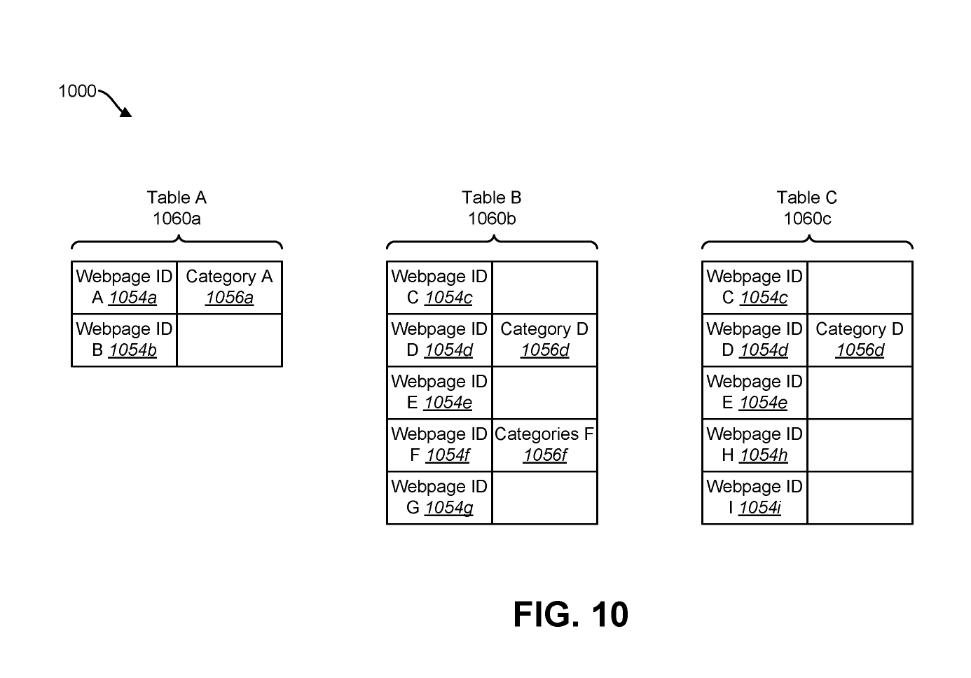

In some approaches, the linking navigation history 118 may be implemented in one or more tables. Each table may include one or more entries corresponding to ordered linking webpages. Accordingly, all preceding entries in order (e.g., lower-numbered rows or higher-numbered rows depending on ordering) relative to an entry for the current webpage may represent linking webpages relative to the current webpage. The portion of the linking navigation history 118 corresponding to the webpage may include one or more preceding entries (e.g., higher row entries or lower row entries, etc.) corresponding to one or more linking webpages in a table (e.g., the table that includes an entry for the current webpage). A separate table (e.g., new table) may be created for non-link navigation, for new tab navigation, and/or for new window navigation. FIG. 10 provides an example of an approach using tables to represent linking webpages in the linking navigation history 118.

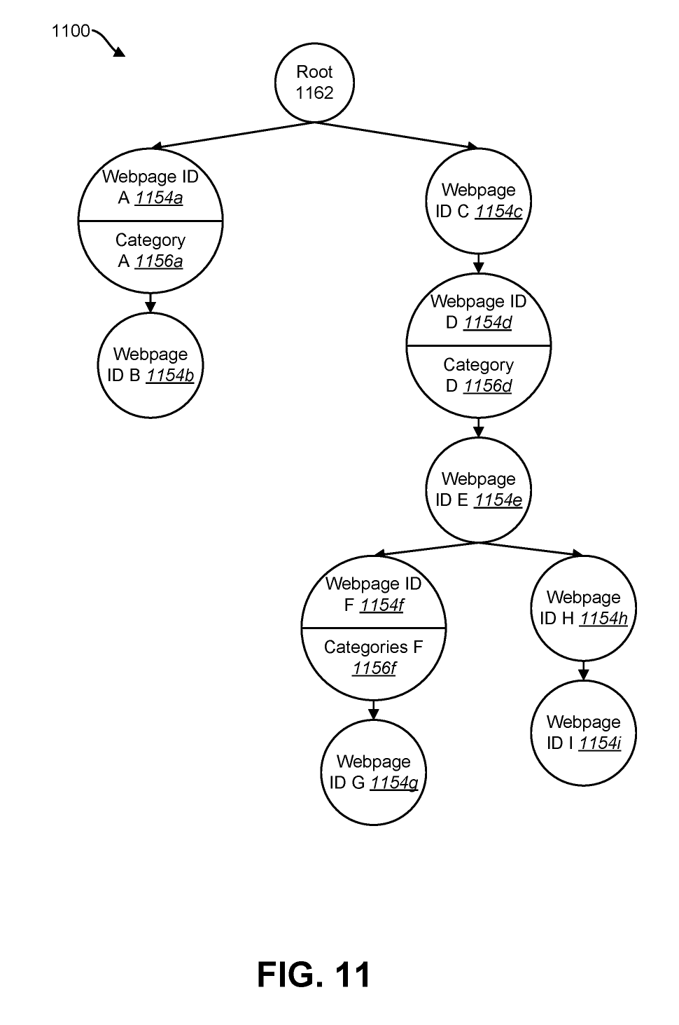

In some approaches, the linking navigation history 118 may be implemented in a tree. The tree may include one or more entries, which may be referred to as nodes. The tree may include a root node (e.g., a root node representing a browsing session). Each node (besides the root, for example) may represent a webpage. Each child node of a parent webpage node may represent a (child) webpage navigated to via a link on the (parent) webpage represented by the parent webpage node. A separate (e.g., new) branch may be created from a webpage node for a link opened in a separate tab or window. A separate (e.g., new) branch may be created from the root node for non-link navigation (e.g., for an address entered directly into the webpage browser or for a new tab or window opened without a link). Accordingly, all parent nodes relative to an entry (e.g., node) for the current webpage may represent linking webpages relative to the current webpage. The portion of the linking navigation history 118 corresponding to the webpage may include one or more parent nodes corresponding to one or more linking webpages in the tree. FIG. 11 provides an example of an approach using a tree to represent linking webpages in the linking navigation history 118.

The electronic device 102 may determine 604 whether the linking navigation history 118 for a webpage is completely traversed based on the structure of the linking navigation history 118. For example, if no further entry (e.g., preceding table entry, parent webpage node, etc.) exists in the portion of the linking navigation history 118 corresponding to the webpage, the linking navigation history may be completely traversed and operation may end 606.

If the electronic device 102 determines 604 that the linking navigation history for a webpage is not completely traversed, the electronic device 102 may determine 608 whether the next linking webpage (represented by a next entry, for example) has a bookmark category. For example, if a further entry (e.g., preceding table entry, parent webpage node, etc.) exists in the portion of the linking navigation history 118 corresponding to the webpage, the electronic device 102 may determine 608 whether the next linking webpage has a bookmark category. This may be accomplished as described in connection with one or more of FIGS. 1-2 and 4. For example, the electronic device 102 may determine whether the webpage represented by the next entry has a categorized bookmark by searching for one or more bookmarks 104 with their associated category(ies) 106 for the webpage and/or by obtaining category information directly from the linking navigation history 118. If the next linking webpage does not have a bookmark category, operation may return to determining 604 whether the linking navigation history 118 for the webpage is completely traversed.

If the next linking webpage has a bookmark category, the electronic device 102 may determine 610 whether the webpage is already bookmarked in the bookmark category. If the webpage already has an associated bookmark in the bookmark category of the linking webpage, operation may return to determining 604 whether the linking navigation history 118 for the webpage is completely traversed (e.g., the electronic device 102 may not duplicate the bookmark).

If the webpage is not already bookmarked in the bookmark category, the electronic device 102 may add 612 a bookmark for the webpage in the category. This may be accomplished as described in connection with one or more of FIGS. 1-4. For example, the electronic device 102 may create a bookmark in the category and/or associate a bookmark for the webpage with the category (corresponding to a linking webpage bookmark category). As can be observed in FIG. 6, one or more steps of the method 600 may repeat (e.g., iterate) until the linking navigation history for the webpage has been traversed.

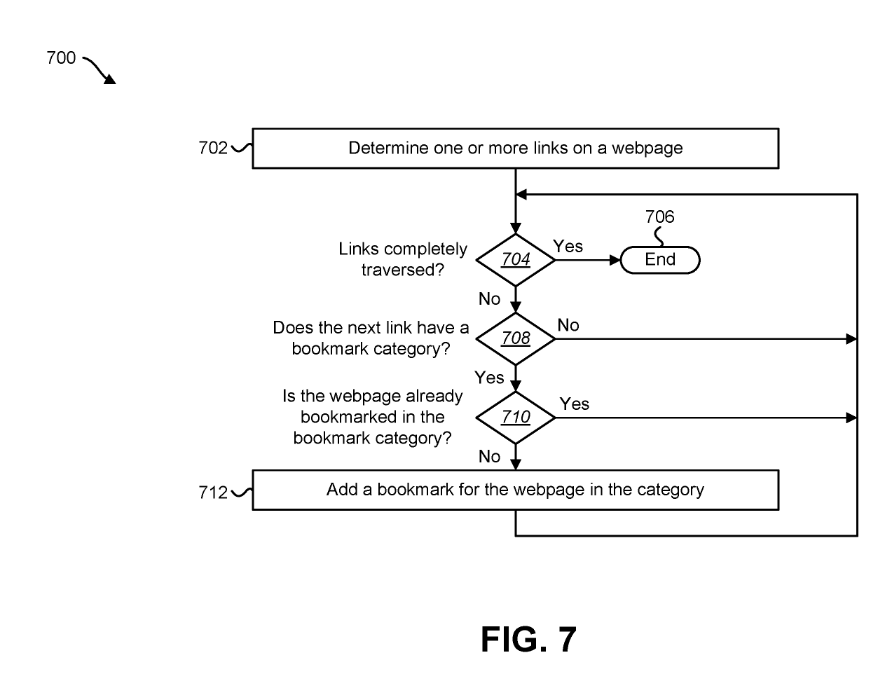

FIG. 7 is a flow diagram illustrating an example of a method 700 for categorizing a bookmark based on one or more links on a webpage. For instance, the method 700 may be performed in cases where it has been determined to add a bookmark. The method 700 may be performed by one or more of the electronic devices described herein (e.g., the electronic device 102 described in connection with FIG. 1).

The electronic device 102 may determine 702 one or more links on a webpage. This may be accomplished as described in connection with one or more of FIGS. 1-2 and 5. For example, the electronic device 102 may search the webpage for one or more links (e.g., links corresponding to hyperlinked content). In some approaches, the links may be stored in one or more data structures (e.g., tables, lists, linked lists, arrays, stacks, heaps, trees, etc.).

The electronic device 102 may determine 704 whether the links for a webpage are completely traversed. For example, the electronic device 102 may determine whether all of the links on a webpage (e.g., the current webpage) have been completely traversed. For instance, the electronic device 102 may determine whether the all the links on the webpage or in a data structure have been checked for bookmark category(ies). In some configurations, the electronic device 102 may determine 704 that all of the links have been traversed if there is no additional link on the webpage and/or in a data structure. If the electronic device 102 determines that the links are completely traversed, operation may end 706.

If the electronic device 102 determines 704 that the links are not completely traversed, the electronic device 102 may determine 708 whether the next link has a bookmark category. This may be accomplished as described in connection with one or more of FIGS. 1-2 and 5. For example, the electronic device 102 may determine whether the link has a categorized bookmark by searching for one or more bookmarks 104 of the link with their associated category(ies) 106. If the next link does not have a bookmark category, operation may return to determining 704 whether the links for the webpage are completely traversed.

If the next link webpage has a bookmark category, the electronic device 102 may determine 710 whether the webpage is already bookmarked in the bookmark category. If the webpage already has an associated bookmark in the bookmark category of the link, operation may return to determining 704 whether the links on the webpage have been completely traversed (e.g., the electronic device 102 may not duplicate the bookmark).

If the webpage is not already bookmarked in the bookmark category, the electronic device 102 may add 712 a bookmark for the webpage in the category. This may be accomplished as described in connection with one or more of FIGS. 1-3 and 5. For example, the electronic device 102 may create a bookmark in the category and/or associate a bookmark for the webpage with the category (corresponding to a link bookmark category). As can be observed in FIG. 7, one or more steps of the method 700 may repeat (e.g., iterate) until the links on the webpage have been traversed.

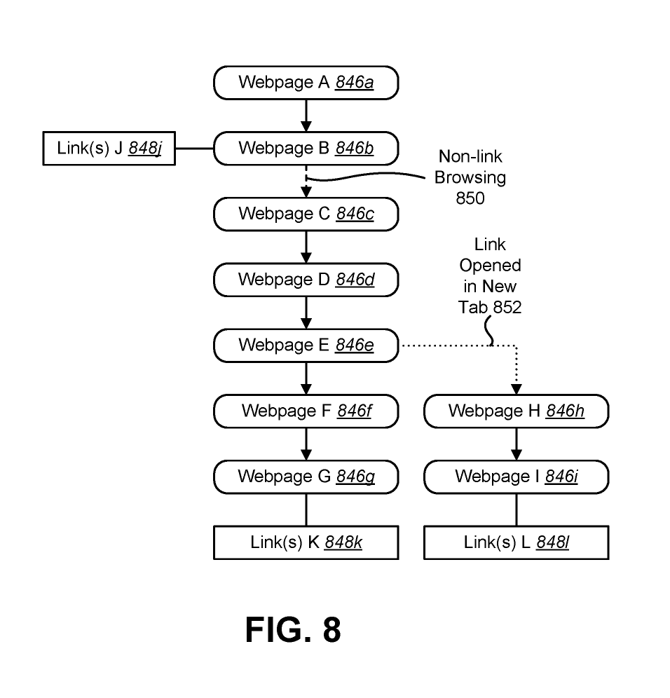

FIG. 8 is a diagram illustrating an example of webpage browsing. In this example, a webpage browsing session may begin with webpage A 846a. For example, webpage A 846a may be a first webpage accessed by a webpage browser in a browsing session. In some approaches, webpage A 846a may be navigated to as a default (e.g., home) webpage, may be navigated to based on a received address (e.g., a URL received by a keyboard or touchscreen), or may be navigated to based on a bookmark or a frequently visited webpage link.

In the example illustrated in FIG. 8, solid line arrows represent link navigation. Accordingly, a link on webpage A 846a is followed to access webpage B 846b. Link(s) J 848j are illustrated as being on webpage B 846b in this example.

In this example, webpage C 846c is accessed via non-link browsing 850. For example, the webpage browser may receive an address (e.g., a URL from a keyboard or touchscreen) to access webpage C 846c. Webpage D 846d is accessed via a link on webpage C 846c. Webpage E 846e is accessed via a link on webpage D 846d.

As can be observed in FIG. 8, webpage H 846h is accessed via a link on webpage E 846e opened in a new tab 852. Webpage I 846i is accessed via a link on webpage H 846h. Link(s) L 8481 are on webpage I 846i.

Additionally, webpage F 846f is accessed via a link on webpage E 846e. Webpage G 846g is accessed via a link on webpage F 846f. Link(s) K 848k are on webpage G 846g.

FIG. 9 is a diagram illustrating one example of a linking navigation history data structure 900 in accordance with the example provided in connection with FIG. 8. In this example, the linking navigation history data structure 900 is a table. The first column in the table includes webpage identifiers (IDs) 954a-i. The webpage IDs 954a-i may include addresses (e.g., URLs) and/or other records of webpages (e.g., strings indicating titles of the webpages, etc.). The second column includes bookmark categories 956a, 956d, 956f associated with webpage ID A 954a (e.g., webpage A 846a), webpage ID D 954d (e.g., webpage D 846d), and webpage ID F 954f (e.g., webpage F 846f), respectively. The third column indicates any inherited category(ies) of linking webpages.

The linking navigation history data structure 900 may be constructed as browsing progresses. For example, the entry with webpage ID A 954a (e.g., the first row) may be added when webpage A 846a is accessed. In this example, webpage A 846a has a bookmark with category A 956a, which is indicated in the entry.

When webpage B 846b is accessed, an entry with webpage ID B 954b may be created. Because webpage B 846b was accessed via a link on webpage A 846a, the electronic device 102 (e.g., processor 112, webpage browser 114, and/or webpage bookmark categorizer 116, etc.) may add inherited category A 958a in the entry with webpage ID B 954b. Inherited category A 958a may be the same category as category A 956a. If it is determined to add a bookmark for webpage B 846b, the electronic device 102 (e.g., processor 112, webpage browser 114, and/or webpage bookmark categorizer 116, etc.) may categorize the bookmark in inherited category A 958a. In some configurations, if webpage B 846b is not bookmarked and the session ends, inherited category A 958a (e.g., the linking navigation history data structure 900) may be discarded.

As described in connection with FIG. 8, webpage C 846c is accessed via non-link browsing. Accordingly, the entry with webpage ID C 846c does not inherit any category (e.g., category A 956a) from previous browsing, since webpage A 846a and webpage B 846b are not linking webpages.

When webpage D 846d is accessed, an entry with webpage ID D 954d may be created. Since webpage C 846c did not have any categorized bookmark, the entry with webpage ID D 954d does not inherit any category from webpage C 846c, even though webpage C 846c is a linking webpage. In this example, webpage D 846d has a bookmark in category D 956d.

When webpage E 846e is accessed, an entry with webpage ID E 954e may be created. Because webpage E 846e was accessed via a link on webpage D 846d, the electronic device 102 (e.g., processor 112, webpage browser 114, and/or webpage bookmark categorizer 116, etc.) may add an inherited category D 958d in the entry with webpage ID E 954e. Inherited category D 958d may be the same category as category D 956d. If it is determined to add a bookmark for webpage E 846e, the electronic device 102 (e.g., processor 112, webpage browser 114, and/or webpage bookmark categorizer 116, etc.) may categorize the bookmark in inherited category D 958d. In some configurations, if webpage E 846e is not bookmarked and the session ends, inherited category D 958d (e.g., the linking navigation history data structure 900) may be discarded.

When webpage F 846f is accessed, an entry with webpage ID F 954f may be created. Because webpage F 846f was accessed via a link on webpage E 846e, the electronic device 102 (e.g., processor 112, webpage browser 114, and/or webpage bookmark categorizer 116, etc.) may add inherited category D 958d in the entry with webpage ID F 954f. Inherited category D 958d may be the same category as category D 956d. In this example, webpage F 846f also has one or more bookmarks in categories F 956f. If it is determined to add a bookmark for webpage F 846f, the electronic device 102 (e.g., processor 112, webpage browser 114, and/or webpage bookmark categorizer 116, etc.) may categorize the bookmark in categories F 956f and inherited category D 958d.

When webpage G 846g is accessed, an entry with webpage ID G 954g may be created. Because webpage G 846g was accessed via a link on webpage F 846f, the electronic device 102 (e.g., processor 112, webpage browser 114, and/or webpage bookmark categorizer 116, etc.) may add inherited categories F 958f and inherited category D 958d in the entry with webpage ID G 954g. If it is determined to add a bookmark for webpage G 846g, the electronic device 102 (e.g., processor 112, webpage browser 114, and/or webpage bookmark categorizer 116, etc.) may categorize the bookmark in inherited categories F 958f and inherited category D 958d.

As described in connection with FIG. 8, webpage H 846h may be accessed via a link from webpage E 846e opened in a new tab 852. When webpage H 846h is accessed, an entry with webpage ID H 954h may be created. Because webpage H 846h was accessed via a link on webpage E 846e, the electronic device 102 (e.g., processor 112, webpage browser 114, and/or webpage bookmark categorizer 116, etc.) may add inherited category D 958d in the entry with webpage ID H 954h. If it is determined to add a bookmark for webpage H 846h, the electronic device 102 (e.g., processor 112, webpage browser 114, and/or webpage bookmark categorizer 116, etc.) may categorize the bookmark in inherited category D 958d.

When webpage I 846i is accessed, an entry with webpage ID I 954i may be created. Because webpage I 846i was accessed via a link on webpage H 846h, the electronic device 102 (e.g., processor 112, webpage browser 114, and/or webpage bookmark categorizer 116, etc.) may add inherited category D 958d in the entry with webpage ID I 954i. If it is determined to add a bookmark for webpage I 846i, the electronic device 102 (e.g., processor 112, webpage browser 114, and/or webpage bookmark categorizer 116, etc.) may categorize the bookmark in inherited category D 958d.

As can be observed in the example in FIG. 9, entries may be created directly in a single table for each webpage. An entry may be created by accessing the entry corresponding to a single preceding linking webpage. One benefit to this approach is that when a bookmark is created, the bookmark may be categorized by accessing only the entry corresponding to the webpage to be bookmarked (e.g., additional entries may not need to be traversed). This approach may utilize more memory in some cases, since each entry may include any bookmark category(ies) for a webpage and any inherited bookmark category(ies). This approach may add the linking navigation history to a browsing history. It should be noted that the data, cells, columns and/or rows of the table may be arranged in different orders.

In cases where browsing returns to an earlier browsed webpage (e.g., using a “back” button), one or more subsequent entries in a corresponding table may be removed (e.g., discarded) or may be provisionally retained. In the removal approach, one or more entries may be added corresponding to subsequent browsing (e.g., an entry may be re-added for a page if the “forward” button is used). In the provisional retention approach, an entry for a webpage may be retained if subsequent browsing returns to the webpage (e.g., if the “forward” button is used). If a different webpage is accessed that does not correspond to the provisionally retained entry, the provisionally retained entry (and any subsequent entry(ies), for example) may be removed (e.g., discarded).

FIG. 10 is a diagram illustrating another example of a linking navigation history data structure 1000 in accordance with the example provided in connection with FIG. 8. In this example, the linking navigation history data structure 1000 includes tables A-C 1060a-c. The first column of each table includes webpage IDs 1054. The optional second column of each table includes one or more bookmark categories 1056. In particular, table A 1060a includes webpage IDs A-B 1054a-b and category A 1056a, table B 1060b includes webpage IDs C-G 1054c-g and category D 1056d and categories F 1056f, and table C 1060c includes webpage IDs C-E 1054c-e and webpage IDs H-I 1054h-i and category D 1056d. The webpage IDs 1054 may include addresses (e.g., URLs) and/or other records of webpages (e.g., strings indicating titles of the webpages, etc.).

In some approaches, entries that represent a webpage with a categorized bookmark may also include a category 1056. In other approaches, the webpage entries (e.g., webpage nodes) that represent a webpage with a categorized bookmark may not include a category (e.g., one or more tables 1060 may not include a column for categories). For example, the electronic device 102 (e.g., processor 112, webpage browser 114, and/or webpage bookmark categorizer 116, etc.) may utilize the linking navigation history data structure 1000 to indicate the linking relationship between webpages, and corresponding bookmarks 104 and/or bookmark categories 106 may be searched based on webpage IDs 1054 for linking webpages.

The linking navigation history data structure 1000 may be constructed as browsing progresses. For example, the entry with webpage ID A 1054a (e.g., the first row) may be added when webpage A 846a is accessed. In this example, webpage A 846a has a bookmark with category A 1056a, which is indicated in the entry.

When webpage B 846b is accessed, an entry with webpage ID B 1054b may be created. Because webpage B 846b was accessed via a link on webpage A 846a, the electronic device 102 (e.g., processor 112, webpage browser 114, and/or webpage bookmark categorizer 116, etc.) may add the entry to the same table (table A 1060a). If it is determined to add a bookmark for webpage B 846b, the electronic device 102 (e.g., processor 112, webpage browser 114, and/or webpage bookmark categorizer 116, etc.) may traverse all preceding entries in table A 1060a (in this case just the entry with webpage ID A 1054a) and categorize the bookmark in category A 1056a. In some configurations, if webpage B 846b is not bookmarked and the session ends, table A 1060a (e.g., the linking navigation history data structure 1000) may be discarded.

As described in connection with FIG. 8, webpage C 846c is accessed via non-link browsing 850. The electronic device 102 (e.g., processor 112, webpage browser 114, and/or webpage bookmark categorizer 116, etc.) may create a new table (table B 1060b) and add an entry for webpage C 846c with webpage ID C 1054c.

When webpage D 846d is accessed, an entry with webpage ID D 1054d may be created. Because webpage D 846d was accessed via a link on webpage C 846c, the entry for webpage D 846d is added to the same table (table B 1060b) as the entry for webpage C 846c. In this example, webpage D 846d has a bookmark in category D 1056d.

When webpage E 846e is accessed, an entry with webpage ID E 1054e may be created. Because webpage E 846e was accessed via a link on webpage D 846d, the electronic device 102 (e.g., processor 112, webpage browser 114, and/or webpage bookmark categorizer 116, etc.) may add the entry for webpage E 846e to the same table as the entry for webpage D 846d. If it is determined to add a bookmark for webpage E 846e, the electronic device 102 (e.g., processor 112, webpage browser 114, and/or webpage bookmark categorizer 116, etc.) may categorize the bookmark in category D 1056d, since category D 1056d is in a preceding entry in table B 1060b.

When webpage F 846f is accessed, an entry with webpage ID F 1054f may be created. Because webpage F 846f was accessed via a link on webpage E 846e, the electronic device 102 (e.g., processor 112, webpage browser 114, and/or webpage bookmark categorizer 116, etc.) may add the entry for webpage F 846f to the same table (table B 1060b) as the entry for webpage E 846e. In this example, webpage F 846f also has one or more bookmarks in categories F 1056f. If it is determined to add a bookmark for webpage F 846f, the electronic device 102 (e.g., processor 112, webpage browser 114, and/or webpage bookmark categorizer 116, etc.) may categorize the bookmark in categories F 1056f and category D 1056d from a preceding entry in table B 1060b.

When webpage G 846g is accessed, an entry with webpage ID G 1054g may be created. Because webpage G 846g was accessed via a link on webpage F 846f, the electronic device 102 (e.g., processor 112, webpage browser 114, and/or webpage bookmark categorizer 116, etc.) may add the entry for webpage G 846g to the same table (table B 1060b) as the entry for webpage F 846f. If it is determined to add a bookmark for webpage G 846g, the electronic device 102 (e.g., processor 112, webpage browser 114, and/or webpage bookmark categorizer 116, etc.) may categorize the bookmark in categories F 1056f and category D 1056d, from preceding entries in table B 1060b.

As described in connection with FIG. 8, webpage H 846h may be accessed via a link from webpage E 846e opened in a new tab 852. When webpage H 846h is accessed, a new table (table C 1060c) with an entry with webpage ID H 1054h may be created. Because webpage H 846h was accessed via a link on webpage E 846e and opened in a new tab (or window), the electronic device 102 (e.g., processor 112, webpage browser 114, and/or webpage bookmark categorizer 116, etc.) may copy entries corresponding to linking webpages relative to webpage H 846h in table C 1060c. For example, the entry for webpage E 846e and all preceding entries in table B 1060b may be copied to table C 1060c. If it is determined to add a bookmark for webpage H 846h, the electronic device 102 (e.g., processor 112, webpage browser 114, and/or webpage bookmark categorizer 116, etc.) may categorize the bookmark in category D 1056d from a preceding entry in table C 1060c.

When webpage I 846i is accessed, an entry with webpage ID I 1054i may be created. Because webpage I 846i was accessed via a link on webpage H 846h, the electronic device 102 (e.g., processor 112, webpage browser 114, and/or webpage bookmark categorizer 116, etc.) may add the entry for webpage I 846i to the same table (table C 1060c) as the entry for webpage H 846h. If it is determined to add a bookmark for webpage I 846i, the electronic device 102 (e.g., processor 112, webpage browser 114, and/or webpage bookmark categorizer 116, etc.) may categorize the bookmark in category D 1056d from a preceding entry in table C 1060c.

As can be observed in the example in FIG. 10, entries may be created in one or more tables 1060 for each webpage. An entry may be created based on whether the corresponding webpage is accessed via a link, via non-link browsing, and/or via opening a new tab or window. When the electronic device 102 is categorizing a bookmark for a webpage, the electronic device 102 may traverse entries in only one table of the linking navigation history data structure 1000 that includes an entry for the webpage.

In cases where browsing returns to an earlier browsed webpage (e.g., using a “back” button), one or more subsequent entries in a corresponding table may be removed (e.g., discarded) or may be provisionally retained. In the removal approach, one or more entries may be added corresponding to subsequent browsing (e.g., an entry may be re-added for a page if the “forward” button is used). In the provisional retention approach, an entry for a webpage may be retained if subsequent browsing returns to the webpage (e.g., if the “forward” button is used). If a different webpage is accessed that does not correspond to the provisionally retained entry, the provisionally retained entry (and any subsequent entry(ies), for example) may be removed (e.g., discarded).

FIG. 11 is a diagram illustrating another example of a linking navigation history data structure 1100 in accordance with the example provided in connection with FIG. 8. In this example, the linking navigation history data structure 1100 includes a tree. The tree includes a root node 1162 (e.g., a session node). The tree may include one or more webpage entries (e.g., webpage nodes). Each webpage node may include a webpage ID 1154. In some approaches, webpage nodes that represent a webpage with a categorized bookmark may also include a category 1156. In other approaches, the webpage entries (e.g., webpage nodes) that represent a webpage with a categorized bookmark may not include a category. For example, the electronic device 102 (e.g., processor 112, webpage browser 114, and/or webpage bookmark categorizer 116, etc.) may utilize the linking navigation history data structure 1100 to indicate the linking relationship, and corresponding bookmarks 104 and/or bookmark categories 106 may be searched based on webpage IDs 1154 for linking webpages. In this example, the tree includes webpage IDs A-I 1154a-i and category A 1156a, D 1156d, and F 1156f. The webpage IDs 1154 may include addresses (e.g., URLs) and/or other records of webpages (e.g., strings indicating titles of the webpages, etc.).

The linking navigation history data structure 1100 may be constructed as browsing progresses. For example, the node with webpage ID A 1154a may be added when webpage A 846a is accessed. In this example, webpage A 846a has a bookmark with category A 1156a, which is indicated in the node.

When webpage B 846b is accessed, a branch and a node with webpage ID B 1154b may be created. Because webpage B 846b was accessed via a link on webpage A 846a, the electronic device 102 (e.g., processor 112, webpage browser 114, and/or webpage bookmark categorizer 116, etc.) may add the node as a child node to the parent node for webpage A 846a. If it is determined to add a bookmark for webpage B 846b, the electronic device 102 (e.g., processor 112, webpage browser 114, and/or webpage bookmark categorizer 116, etc.) may traverse all parent webpage nodes (e.g., grandparent nodes, etc.) of the node for webpage B 846b (in this case just the node with webpage ID A 1154a) and categorize the bookmark in category A 1156a.

As described in connection with FIG. 8, webpage C 846c is accessed via non-link browsing 850. The electronic device 102 (e.g., processor 112, webpage browser 114, and/or webpage bookmark categorizer 116, etc.) may create another branch from the root node 1162 and add a node for webpage C 846c with webpage ID C 1154c.

When webpage D 846d is accessed, a branch and a node with webpage ID D 1154d may be created. Because webpage D 846d was accessed via a link on webpage C 846c, the electronic device 102 (e.g., processor 112, webpage browser 114, and/or webpage bookmark categorizer 116, etc.) may add the node as a child node to the parent node for webpage C 846c. In this example, webpage D 846d has a bookmark in category D 1156d.

When webpage E 846e is accessed, a branch and a node with webpage ID E 1154e may be created. Because webpage E 846e was accessed via a link on webpage D 846d, the electronic device 102 (e.g., processor 112, webpage browser 114, and/or webpage bookmark categorizer 116, etc.) may add the node as a child node to the parent node for webpage D 846d. If it is determined to add a bookmark for webpage E 846e, the electronic device 102 (e.g., processor 112, webpage browser 114, and/or webpage bookmark categorizer 116, etc.) may categorize the bookmark in category D 1156d, since category D 1156d is in a parent node relative to the node for webpage E 846e.

When webpage F 846f is accessed, a branch and a node with webpage ID F 1154f may be created. Because webpage F 846f was accessed via a link on webpage E 846e, the electronic device 102 (e.g., processor 112, webpage browser 114, and/or webpage bookmark categorizer 116, etc.) may add the node as a child node to the parent node for webpage E 846e. In this example, webpage F 846f also has one or more bookmarks in categories F 1156f. If it is determined to add a bookmark for webpage F 846f, the electronic device 102 (e.g., processor 112, webpage browser 114, and/or webpage bookmark categorizer 116, etc.) may categorize the bookmark in categories F 1156f and category D 1156d from a parent node in the tree.

When webpage G 846g is accessed, a node with webpage ID G 1154g may be created. Because webpage G 846g was accessed via a link on webpage F 846f, the electronic device 102 (e.g., processor 112, webpage browser 114, and/or webpage bookmark categorizer 116, etc.) may add the node as a child node to the parent node for webpage F 846f. If it is determined to add a bookmark for webpage G 846g, the electronic device 102 (e.g., processor 112, webpage browser 114, and/or webpage bookmark categorizer 116, etc.) may categorize the bookmark in categories F 1156f and category D 1156d, from parent nodes in the tree.

As described in connection with FIG. 8, webpage H 846h may be accessed via a link from webpage E 846e opened in a new tab 852. When webpage H 846h is accessed, another branch with a node with webpage ID H 1154h may be created. Because webpage H 846h was accessed via a link on webpage E 846e and opened in a new tab (or window), the electronic device 102 (e.g., processor 112, webpage browser 114, and/or webpage bookmark categorizer 116, etc.) may add the node as a child node to the parent node for webpage E 846e in the tree. For example, the node for webpage E 846e and all corresponding parent nodes in the tree may represent linking webpages relative to webpage H 846h. If it is determined to add a bookmark for webpage H 846h, the electronic device 102 (e.g., processor 112, webpage browser 114, and/or webpage bookmark categorizer 116, etc.) may categorize the bookmark in category D 1156d from a parent node in the tree.

When webpage I 846i is accessed, a branch and a node with webpage ID I 1154i may be created. Because webpage I 846i was accessed via a link on webpage H 846h, the electronic device 102 (e.g., processor 112, webpage browser 114, and/or webpage bookmark categorizer 116, etc.) may add the node as a child node to the parent node for webpage H 846h. If it is determined to add a bookmark for webpage I 846i, the electronic device 102 (e.g., processor 112, webpage browser 114, and/or webpage bookmark categorizer 116, etc.) may categorize the bookmark in category D 1156d from a parent node in the tree.

As can be observed in the example in FIG. 11, branches and/or nodes may be created in the tree based on whether webpage access is via a linking webpage, via a linking webpage in a separate tab or window, or without a linking webpage. For example, a first branch may be created from a current node in a case that the webpage access is via a linking webpage, a second branch may be created from the current node in a case that the webpage access is via a linking webpage in a separate tab or window, or a branch from a root node may be created in a case that the webpage access is without a linking webpage. When the electronic device 102 is categorizing a bookmark for a webpage, the electronic device 102 may traverse only nodes in a parental relationship (e.g., in a parental line) from the node representing the webpage. For example, the linking navigation history for a webpage may include the node representing the webpage and any webpage node in a parental relationship with the node (back to the root node 1162, for example).

In cases where browsing returns to an earlier browsed webpage (e.g., using a “back” button), a corresponding child node may be retained or may be provisionally retained. In the retaining approach, no node is removed from the tree (except when the linking navigation history is discarded, for example) and one or more additional child nodes may be added corresponding to subsequent browsing (e.g., a previously created node may be utilized for a page if the “forward” button is used and/or other child node(s) may be added if browsing follows a different path from that node). In the provisional retention approach, a child node may be discarded and/or replaced with a node if subsequent browsing takes a different path than the previous path. It should be noted that the tree approach may be beneficial, since each entry (e.g., node) in the tree may exclusively correspond to a webpage (no duplicate nodes for the same webpage). Additionally or alternatively, bookmark categories may not be duplicated.

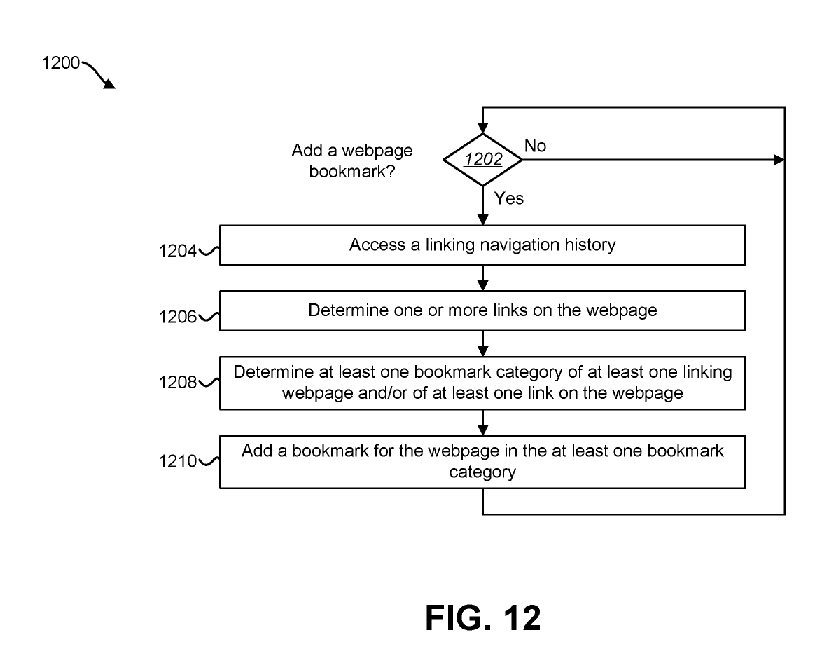

FIG. 12 is a flow diagram illustrating a configuration of a method 1200 for categorizing webpage bookmarks based on any linking webpage(s) and/or any link(s) on a webpage. The method 1200 may be performed by one or more of the electronic devices described herein (e.g., the electronic device 102 described in connection with FIG. 1). The electronic device 102 may determine 1202 whether to add a bookmark for a webpage. This may be accomplished as described in connection with one or more of FIGS. 1-2 and 4-5. As illustrated in FIG. 12, the electronic device 102 may wait until it is determined 1202 to add a bookmark for a webpage.

In a case that the electronic device 102 determines 1202 to add a webpage bookmark, the electronic device 102 may access 1204 a linking navigation history 118. This may be accomplished as described in connection with FIG. 4. For example, the electronic device 102 may read the linking navigation history 118 relative to the current webpage.

The electronic device 102 may determine 1206 one or more links on the webpage. This may be accomplished as described in connection with FIG. 5.

The electronic device 102 may determine 1208 at least one bookmark category of at least one linking webpage and/or of at least one link on the webpage. This may be accomplished as described in connection with one or more of FIGS. 1-11.

The electronic device 102 may add 1210 a webpage bookmark in the at least one bookmark category. This may be accomplished as described in connection with one or more of FIGS. 1-11.

FIG. 13 is a flow diagram illustrating a configuration of a method 1300 for building a linking navigation history 118. The method 1300 may be performed by one or more of the electronic devices described herein (e.g., the electronic device 102 described in connection with FIG. 1).

The electronic device 102 may access 1302 a webpage. For example, the electronic device 102 (e.g., webpage browser 114) may obtain a webpage address (e.g., a URL from a keyboard or touchscreen, a webpage address based on a link indicated by an input, etc.). The electronic device 102 may send a request to access a webpage and/or may receive the webpage from a remote device. In some configurations, the electronic device 102 may additionally or alternatively load a cached webpage or a portion thereof from memory 122.

The electronic device 102 may create 1304 a data structure entry corresponding to the webpage based on whether the webpage was accessed via a linking webpage, linking webpage in a new tab, or no linking webpage. In some configurations, the entry may include any bookmark category(ies) (or one or more indicators thereof) corresponding to the webpage. For example, the electronic device 102 may obtain one or more bookmark category(ies) 106 corresponding to the webpage from the memory 122. In some configurations, the entry may not explicitly indicate any corresponding bookmark category. For example, the entry itself (e.g., a webpage ID) may implicitly indicate and/or may be utilized to determine any corresponding bookmark category(ies).

The electronic device 102 may determine 1306 whether to add a webpage bookmark. This may be accomplished as described in connection with one or more of FIGS. 1-2 and 4-5.

If it is not determined 1306 to add a webpage bookmark (e.g., if no input is received indicating a command to bookmark and/or it is not automatically determined to add a bookmark), the electronic device 102 may determine 1316 whether to browse to a next webpage. For example, the electronic device 102 may determine whether an input is received (e.g., a touch, a click, a keyboard input, a touchscreen input, etc.) indicating a command to browse to a next webpage. As illustrated in FIG. 13, the electronic device 102 may await browsing to a next webpage (until it is determined 1316 to browse to a next webpage, for example). If it is determined 1316 to browse to a next webpage, the electronic device 102 may access 1302 the webpage. It should be noted that a browsing session may end in some instances. In some configurations, the electronic device 102 may discard the linking navigation history corresponding to the browsing session when the browsing session is ended. (e.g., when the webpage browser 114 is closed).

If it is determined 1306 to add a webpage bookmark, the electronic device 102 may determine 1308 any bookmark category(ies) corresponding to any link(s) on the webpage. This may be accomplished as described in connection with one or more of FIGS. 1-2,5, and 7. For example, the electronic device 102 may determine all links on the webpage (if any) and determine the category(ies) of one or more categorized bookmarks corresponding to the link(s), if any.

The electronic device 102 may determine 1310 whether there are any linking webpage(s) in the data structure with one or more bookmark categories and/or any link(s) with one or more bookmark categories. If there is no bookmark category corresponding to any linking webpage(s) and/or link(s), the electronic device 102 may add 1312 a webpage bookmark. This may be accomplished as described in connection with one or more of FIGS. 4-5. For example, the electronic device 102 may add 1312 a webpage bookmark without a category or with a new or existing category. The electronic device 102 may proceed to determine 1316 whether to browse to a next webpage.

If there are one or more bookmark categories corresponding to any linking webpage(s) and/or link(s), the electronic device 102 may add 1314 a bookmark for the webpage in the one or more categories. This may be accomplished as described in connection with one or more of FIGS. 1-7 and 9-12.

The electronic device 102 may determine 1316 whether to browse to a next webpage. The electronic device 102 may wait to browse to a next webpage until it is determined 1316 to browse to a next webpage (e.g., until an input is received indicating browsing to a next webpage). As illustrated in FIG. 13, one or more steps of the method 1300 may repeat during browsing.

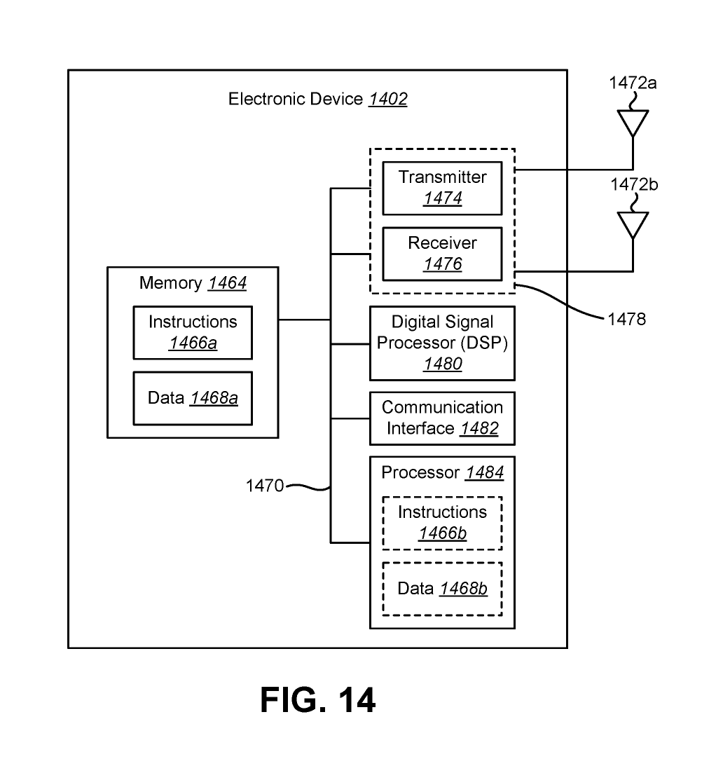

FIG. 14 illustrates certain components that may be included within an electronic device 1402 configured to implement various configurations of the systems and methods disclosed herein. Examples of the electronic device 1402 may include cellular phones, smart phones, computers (e.g., desktop computers, laptop computers, etc.), tablet devices, media players, televisions, vehicles, automobiles, cameras, virtual reality devices (e.g., headsets), augmented reality devices (e.g., headsets), mixed reality devices (e.g., headsets), aircraft, healthcare equipment, gaming consoles, personal digital assistants (PDAs), set-top boxes, appliances, etc. The electronic device 1402 may be implemented in accordance with the electronic device 102 described in connection with FIG. 1.

The electronic device 1402 includes a processor 1484. The processor 1484 may be a general purpose single- or multi-chip microprocessor (e.g., an ARM), a special purpose microprocessor (e.g., a digital signal processor (DSP)), a microcontroller, a programmable gate array, etc. The processor 1484 may be referred to as a central processing unit (CPU). Although just a single processor 1484 is shown in the electronic device 1402, in an alternative configuration, a combination of processors (e.g., an ARM and DSP) could be implemented.

The electronic device 1402 also includes memory 1464. The memory 1464 may be any electronic component capable of storing electronic information. The memory 1464 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 1468a and instructions 1466a may be stored in the memory 1464. The instructions 1466a may be executable by the processor 1484 to implement one or more of the methods, procedures, steps, and/or functions described herein. Executing the instructions 1466a may involve the use of the data 1468a that is stored in the memory 1464. When the processor 1484 executes the instructions 1466, various portions of the instructions 1466b may be loaded onto the processor 1484 and/or various pieces of data 1468b may be loaded onto the processor 1484.

The electronic device 1402 may also include a transmitter 1474 and a receiver 1476 to allow transmission and reception of signals to and from the electronic device 1402. The transmitter 1474 and receiver 1476 may be collectively referred to as a transceiver 1478. One or more antennas 1472a-b may be electrically coupled to the transceiver 1478. The electronic device 1402 may also include (not shown) multiple transmitters, multiple receivers, multiple transceivers and/or additional antennas.

The electronic device 1402 may include a digital signal processor (DSP) 1480. The electronic device 1402 may also include a communication interface 1482. The communication interface 1482 may allow and/or enable one or more kinds of input and/or output. For example, the communication interface 1482 may include one or more ports and/or communication devices for linking other devices to the electronic device 1402. In some configurations, the communication interface 1482 may include the transmitter 1474, the receiver 1476, or both (e.g., the transceiver 1478). Additionally or alternatively, the communication interface 1482 may include one or more other interfaces (e.g., touchscreen, keypad, keyboard, microphone, camera, etc.). For example, the communication interface 1482 may enable a user to interact with the electronic device 1402.

The various components of the electronic device 1402 may be coupled together by one or more buses, which may include a power bus, a control signal bus, a status signal bus, a data bus, etc. For the sake of clarity, the various buses are illustrated in FIG. 14 as a bus system 1470.

The term “determining” encompasses a wide variety of actions and, therefore, “determining” can include calculating, computing, processing, deriving, investigating, looking up (e.g., looking up in a table, a database or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes, and variations may be made in the arrangement, operation, and details of the systems, methods, and apparatus described herein without departing from the scope of the claims.

What is claimed is:

1. A method for webpage bookmark categorization, comprising:
determining to add a bookmark for a webpage;
accessing a linking navigation history;
determining at least one bookmark category of at least one linking webpage based on the linking navigation history or of at least one link on the webpage; and
adding a bookmark for the webpage in the at least one bookmark category.

2. The method of claim 1, wherein the linking navigation history indicates whether navigation to the webpage was accomplished with or without linking.

3. The method of claim 1, wherein:
determining the at least one bookmark category of the at least one linking webpage comprises accessing at least a portion of a linking navigation history data structure; and wherein
adding the bookmark for the webpage comprises categorizing the bookmark in each bookmark category indicated by the at least a portion of the linking navigation history data structure.

4. The method of claim 1, wherein determining the at least one bookmark category of the at least one link on the webpage comprises determining whether each of the at least one link has a corresponding bookmark category.

5. The method of claim 4, wherein adding the bookmark for the webpage comprises categorizing the bookmark in each bookmark category corresponding to the at least one link.

6. The method of claim 1, further comprising creating a linking navigation history data structure based on one or more webpage accesses.

7. The method of claim 6, wherein creating the linking navigation history data structure comprises, for each of the one or more webpage accesses, creating a data structure entry corresponding to a webpage access based on whether the webpage access is via a linking webpage, via a linking webpage in a separate tab or window, or without a linking webpage.

8. The method of claim 7, wherein the linking navigation history data structure comprises a tree, wherein creating the data structure entry corresponding to the webpage access comprises creating a first branch from a current node in a case that the webpage access is via a linking webpage, creating a second branch from the current node in a case that the webpage access is via a linking webpage in a separate tab or window, or creating a branch from a root node in a case that the webpage access is without a linking webpage.

9. The method of claim 7, wherein the linking navigation history data structure comprises a table, wherein creating the data structure entry corresponding to the webpage access comprises creating a category inheriting table entry in a case that the webpage access is via a linking webpage, creating a category inheriting table entry in a case that the webpage access is via a linking webpage in a separate tab or window, or creating a non-inheriting table entry in a case that the webpage access is without a linking webpage.

10. The method of claim 7, wherein creating the data structure entry corresponding to the webpage access comprises creating a table entry in a table in a case that the webpage access is via a linking webpage, creating a table entry in a new table in a case that the webpage access is via a linking webpage in a separate tab or window, or creating a table entry in a separate table in a case that the webpage access is without a linking webpage.

11. An electronic device for webpage bookmark categorization, comprising:
a processor configured to:
determine to add a bookmark for a webpage;
access a linking navigation history;
determine at least one bookmark category of at least one linking webpage based on the linking navigation history or of at least one link on the webpage; and
add a bookmark for the webpage in the at least one bookmark category.

12. The electronic device of claim 11, wherein the linking navigation history indicates whether navigation to the webpage was accomplished with or without linking.

13. The electronic device of claim 11, wherein the processor is configured to determine the at least one bookmark category of the at least one linking webpage by accessing at least a portion of a linking navigation history data structure, and wherein the processor is configured to add the bookmark for the webpage by categorizing the bookmark in each bookmark category indicated by the at least a portion of the linking navigation history data structure.

14. The electronic device of claim 11, wherein the processor is configured to determine the at least one bookmark category of the at least one link on the webpage by determining whether each of the at least one link has a corresponding bookmark category.

15. The electronic device of claim 14, wherein the processor is configured to add the bookmark for the webpage by categorizing the bookmark in each bookmark category corresponding to the at least one link.

16. The electronic device of claim 11, wherein the processor is configured to create a linking navigation history data structure based on one or more webpage accesses.

17. The electronic device of claim 16, wherein the processor is configured to create the linking navigation history data structure by, for each of the one or more webpage accesses, creating a data structure entry corresponding to a webpage access based on whether the webpage access is via a linking webpage, via a linking webpage in a separate tab or window, or without a linking webpage.

18. The electronic device of claim 17, wherein the linking navigation history data structure comprises a tree, wherein the processor is configured to create the data structure entry corresponding to the webpage access by creating a first branch from a current node in a case that the webpage access is via a linking webpage, creating a second branch from the current node in a case that the webpage access is via a linking webpage in a separate tab or window, or creating a branch from a root node in a case that the webpage access is without a linking webpage.

19. The electronic device of claim 17, wherein the linking navigation history data structure comprises a table, wherein the processor is configured to create the data structure entry corresponding to the webpage access by creating a category inheriting table entry in a case that the webpage access is via a linking webpage, creating a category inheriting table entry in a case that the webpage access is via a linking webpage in a separate tab or window, or creating a non-inheriting table entry in a case that the webpage access is without a linking webpage.

20. The electronic device of claim 17, wherein the processor is configured to create the data structure entry corresponding to the webpage access by creating a table entry in a table in a case that the webpage access is via a linking webpage, creating a table entry in a new table in a case that the webpage access is via a linking webpage in a separate tab or window, or creating a table entry in a separate table in a case that the webpage access is without a linking webpage.

21. A computer-program product for webpage bookmark categorization, comprising a non-transitory tangible computer-readable medium having instructions thereon, the instructions comprising:
code for causing an electronic device to determine to add a bookmark for a webpage;
code for causing the electronic device to access a linking navigation history;
code for causing the electronic device to determine at least one bookmark category of at least one linking webpage based on the linking navigation history or of at least one link on the webpage; and
code for causing the electronic device to add a bookmark for the webpage in the at least one bookmark category.

22. The computer-program product of claim 21, wherein the linking navigation history indicates whether navigation to the webpage was accomplished with or without linking.

23. The computer-program product of claim 21, wherein:
the code for causing the electronic device to determine the at least one bookmark category of the at least one linking webpage comprises code for causing the electronic device to access at least a portion of a linking navigation history data structure; and wherein
the code for causing the electronic device to add the bookmark for the webpage comprises code for causing the electronic device to categorize the bookmark in each bookmark category indicated by the at least a portion of the linking navigation history data structure.

24. The computer-program product of claim 21, wherein the code for causing the electronic device to determine the at least one bookmark category of the at least one link on the webpage comprises code for causing the electronic device to determine whether each of the at least one link has a corresponding bookmark category.

25. The computer-program product of claim 21, further comprising code for causing the electronic device to create a linking navigation history data structure based on one or more webpage accesses.

26. An apparatus for webpage bookmark categorization, comprising:
means for determining to add a bookmark for a webpage;
means for accessing a linking navigation history;
means for determining at least one bookmark category of at least one linking webpage based on the linking navigation history or of at least one link on the webpage; and
means for adding a bookmark for the webpage in the at least one bookmark category.

27. The apparatus of claim 26, wherein the linking navigation history indicates whether navigation to the webpage was accomplished with or without linking.

28. The apparatus of claim 26, wherein:
the means for determining the at least one bookmark category of the at least one linking webpage comprises means for accessing at least a portion of a linking navigation history data structure; and wherein
the means for adding the bookmark for the webpage comprises means for categorizing the bookmark in each bookmark category indicated by the at least a portion of the linking navigation history data structure.

29. The apparatus of claim 26, wherein the means for determining the at least one bookmark category of the at least one link on the webpage comprises means for determining whether each of the at least one link has a corresponding bookmark category.

30. The apparatus of claim 26, further comprising means for creating a linking navigation history data structure based on one or more webpage accesses.
